(19) United States
(12) Patent Application Publication
(10) Pub. No.: US 2018/0346740 A1
(43) Pub. Date: Dec. 6, 2018

(54) PROCESS FOR PRODUCING A MULTICOAT PAINT SYSTEM

(71) Applicant: BASF Coating GmbH, Muenster (DE)

(72) Inventors: Audree ANDERSEN, Havixbeck (DE); Hardy REUTER, Muenster (DE); Roland RATZ, Everswinkel (DE); Marita BUERMANN, Muenster (DE); Juergen BAUER, Graefelfing (DE); Vera DIEPENBROCK, Everswinkel (DE); Sina WINNEN, Muenchen (DE)

(73) Assignee: BASF Coating GmbH, Muenster (DE)

(21) Appl. No.: 15/571,272

(22) PCT Filed: Mar. 30, 2016
(86) PCT No.: PCT/EP2016/056894

§ 371 Date: Nov. 2, 2017

(30) Foreign Application Priority Data
May 6, 2015 (EP) 15166539.5

(51) Int. Cl. C09D 5/44; C09D 5/00; C09D 175/04; B05D 7/14; B05D 7/00; C25D 13/04

(52) U.S. Cl. CPC C09D 5/4465; C09D 5/002; C09D 5/4476; C25D 13/04; C09D 175/04; B05D 7/14; B05D 7/577; C09D 5/4473

(57) ABSTRACT

The present invention relates to a process for producing a multicoat paint system on a metallic substrate, by producing a basecoat film or two or more directly successive basecoat films directly on a metallic substrate coated with a cured electrocoat system, producing a clearcoat directly on the one or the topmost of the two or more basecoat films, and then jointly curing the one or the two or more basecoat films and the clearcoat film, and which comprises at least one basecoat material used in producing the basecoat films comprising at least one aqueous polyurethane-polyurea dispersion (PD) comprising polyurethane-polyurea particles, with the polyurethane-polyurea particles present in the dispersion (PD) comprising anionic groups and/or groups which can be converted into anionic groups, and having an average particle size of 40 to 2000 nm and also a gel fraction of at least 50%.

The present invention relates to a process for producing a multicoat paint system by producing a basecoat film or two or more directly successive basecoat films directly on a metallic substrate coated with a cured electrocoat system, producing a clearcoat film directly on the one or the topmost of the two or more basecoat films, and then jointly curing the one or the two or more basecoat films and the clearcoat film. The present invention further relates to a multicoat paint system produced by the process of the invention.

### PRIOR ART

Multicoat paint systems on metallic substrates, examples being multicoat paint systems in the automobile industry sector, are known. Generally speaking, multicoat paint systems of these kinds, considered from the metallic substrate outward, comprise an electrocoat, a coat which is applied directly to the electrocoat and is usually referred to as a surfacer coat, at least one coat which comprises color pigments and/or effect pigments and which is generally referred to as a basecoat, and also a clearcoat.

The fundamental compositions and functions of the stated coats, and of the coating materials necessary for the construction of these coats—that is, electrocoat materials, surfacers, coating materials comprising color and/or effect pigments and known as basecoat materials, and clearcoat materials—are known. Thus, for example, the fundamental purpose of the electrophoretically applied electrocoat is to protect the substrate from corrosion. The primary function of the surfacer coat is to provide protection from mechanical exposure such as stone chipping, for example, and also to fill out unevennesses in the substrate. The next coat, termed the basecoat, is primarily responsible for producing esthetic qualities such as the color and/or effects such as the flock, while the clearcoat that then follows serves in particular to provide the multicoat paint system with scratch resistance and also with gloss.

Producing these multicoat paint systems generally involves first depositing or applying an electrocoat material, more particularly a cathodic electrocoat material, electrophoretically on the metallic substrate, such as an automobile body, for example. The metallic substrate may undergo various pretreatments prior to the deposition of the electrocoat material—for example, known conversion coatings such as phosphate coatings, more particularly zinc phosphate coats, may be applied. The operation of depositing the electrocoat material takes place in general in corresponding electrocoating tanks. Following application, the coated substrate is removed from the tank and is optionally rinsed and subjected to flashing and/or interim drying, and lastly the applied electrocoat material is cured. The aim here is for film thicknesses of approximately 15 to 25 micrometers. The surfacer material is then applied directly to the cured electrocoat, and is optionally subjected to flashing and/or interim drying, and is thereafter cured. To allow the cured surfacer coat to fulfill the objectives identified above, the aim is for film thicknesses of 25 to 45 micrometers, for example. Applied directly to the cured surfacer coat, subsequently, is a basecoat material comprising color and/or effect pigments, which is optionally subjected to flashing and/or interim drying, with a clearcoat material being applied directly to the basecoat film thus produced, without separate curing. Subsequently the basecoat film and any clearcoat film that has likewise been subjected to flashing and/or interim drying beforehand are jointly cured (wet-on-wet method). Whereas the cured basecoat in principle has comparatively low film thicknesses of 10 to 20 micrometers, for example, film thicknesses of 30 to 60 micrometers, for example, are the target for the cured clearcoat, in order to achieve the technological applications properties described. The application of surfacer, basecoat, and clearcoat materials may take place, for example, via the methods of pneumatic and/or electrostatic spray application that are known to the skilled person. At the present time, surfacer and basecoat materials are already being employed increasingly in the form of aqueous coating materials, on environmental grounds. Multicoat paint systems of these kinds and processes for producing them are described in, for example, DE 199 48 004 A1, page 17, line 37, to page 19, line 22, or else DE 100 43 405 C1, column 3, paragraph [0018], and column 8, paragraph [0052] to column 9, paragraph [0057], in conjunction with column 6, paragraph [0039] to column 8, paragraph [0050].

Although the multicoat paint systems produced in this way are generally able to fulfill the requirements imposed by the automobile industry, in terms of technological application properties and esthetic profile, environmental and economic factors nowadays mean that, more and more, a simplification to the comparatively complex production operation described is coming into the spotlight of the automakers.

Thus there are approaches where attempts are made to do without the separate step of curing the coating material applied directly to the cured electrocoat (the coating material referred to as surfacer in the context of the standard process described above), and also, optionally, reducing the film thickness of the coating film produced from this coating material. Within the art, then, this coating film which is not separately cured is frequently referred to as basecoat film (and no longer as surfacer film) or is referred to as first basecoat film to distinguish it from a second basecoat film which is applied to it. In some cases, indeed, attempts are made to do entirely without this coating film (in which case, then, only one so-called basecoat film is produced directly on the electrocoat, and is overcoated, without a separate curing step, with a clearcoat material, meaning that ultimately there is a separate curing step forgone likewise). In place of the separate curing step and in place of an additional final curing step, therefore, the intention is that there should be only one final curing step following application of all of the coating films applied to the electrocoat.

Forgoing a separate curing step for the coating material applied directly to the electrocoat is very advantageous on environmental and economic grounds. The reason is that it leads to a saving in energy, and the overall production operation can of course proceed with substantially greater stringency.

Instead of the separate curing step, then, it is an advantage for the coating film produced directly on the electrocoat to merely undergo flashing at room temperature and/or interim drying at elevated temperatures, without carrying out a curing operation, which as is known generally entails elevated curing temperatures and/or long curing times.

A problem, however, is that with this form of production, it is nowadays often not possible to achieve the requisite technological performance and esthetic properties.

For instance, dispensing with the separate curing of the coating film applied directly to the electrocoat, such as the curing of the first basecoat film, for example, prior to the application of further coating materials, such as a second basecoat material and a clearcoat material, for example, may give rise to unwanted inclusions of air, of solvent and/or of moisture, and these inclusions may become noticeable in the form of bubbles beneath the surface of the overall paint system and may burst in the course of the final cure. The holes produced as a result in the paint system, also called pinholes and pops, lead to a deleterious visual appearance. The amount of organic solvent and/or water, and also the amount of air introduced by the application procedure, as a result of the overall system encompassing first basecoat, second basecoat, and clearcoat, is too great for the entire amount to be able to escape from the multicoat paint system in the course of a final curing step without the generation of defects. In the case of a conventional production operation described above, where the surfacer film is baked separately before the production of a usually comparatively thin basecoat film (which therefore comprises only comparatively little air, organic solvents and/or water), the solution to this problem is of course much less of a challenge.

However, even in the production of multicoat paint systems where use of the coating material referred to in the standard operation as surfacer is completely abandoned, in other words systems where only a basecoat material is applied directly to the cured electrocoat, the problems described with pinholes and pops are frequently encountered. The reason is that depending on the application and service of the multicoat paint system being produced, in the case of complete abandonment of the coating referred to as a surfacer coat in the standard operation, the basecoat film thickness required is generally greater by comparison with the standard systems in order for the desired properties to be obtained. In this case, therefore, the overall film thickness of coating films which have to be cured in the final curing step is also substantially higher than in the standard operation.

Other relevant properties too, however, are not always satisfactorily achieved when multicoat paint systems are constructed using the process described. A challenge is posed accordingly, for example, by the attainment of a high-grade overall appearance, which is influenced in particular by good flow of the coating materials used. In this case the rheological properties of the coating materials must be tailored appropriately to the operational regime described. Similar comments apply in respect of mechanical properties such as the adhesion. In this connection as well, attaining an appropriate quality represents a great challenge.

Furthermore, the environmental profile of such multicoat paint systems is still ripe for improvement. Replacing a significant fraction of organic solvents by water in aqueous coating materials already makes a corresponding contribution. But a significant improvement would be achievable through the increase in the solids content of such coating materials. It is nevertheless specifically in aqueous basecoat materials which comprise color and/or effect pigments that increasing the solids content while at the same time preserving commensurate rheological properties and hence a good appearance is very difficult.

It would be advantageous accordingly to have a process for producing multicoat paint systems that allows a separate curing step, as described above, for the coating material applied directly to the electrocoat to be dispensed with and the multicoat paint system produced nevertheless exhibits excellent technological application properties and esthetic properties.

### OBJECT

An object of the present invention, accordingly, was to find a process for producing a multicoat paint system on metallic substrates wherein the coating material applied directly to the electrocoat system is not cured separately, but instead wherein this coating material is instead cured in a joint curing step with further coating films applied thereafter. In spite of this process simplification, the resulting multicoat paint systems ought to exhibit outstanding stability with respect to pinholes. It ought, moreover, to be possible in this way, depending on requirements and individual field of use, to provide multicoat paint systems in which the one coating film or the two or more coating films disposed between electrocoat and clearcoat can have variable film thicknesses, and in which, in particular, there are no problems with pinholes occurring even at relatively high film thicknesses. Other properties of the multicoat paint systems too, more particularly the overall appearance and the adhesion, ought to be of high quality and ought at least to be at the level achievable by way of the standard process described above.

### TECHNICAL SOLUTION

It has been found that the stated objects can be achieved by a new process for producing a multicoat paint system (M) on a metallic substrate (S), comprising

(1) producing a cured electrocoat (E.1) on the metallic substrate (S) by electrophoretic application of an electrocoat material (e.1) to the substrate (S) and subsequent curing of the electrocoat material (e.1),

(2) producing (2.1) a basecoat film (B.2.1) or (2.2) two or more directly successive basecoat films (B.2.2.x) directly on the cured electrocoat (E.1) by (2.1) application of an aqueous basecoat material (b.2.1) directly to the electrocoat (E.1) or (2.2) directly successive application of two or more basecoat materials (b.2.2.x) to the electrocoat (E.1),

(3) producing a clearcoat film (K) directly on (3.1) the basecoat film (B.2.1), or (3.2) the topmost basecoat film (B.2.2.x) by application of a clearcoat material (k) directly to (3.1) the basecoat film (B.2.1) or (3.2) the topmost basecoat film (B.2.2.x),

(4) jointly curing the (4.1) basecoat film (B.2.1) and the clearcoat film (K) or (4.2) the basecoat films (B.2.2.x) and the clearcoat (K),
wherein
the basecoat material (b.2.1) or at least one of the basecoat materials (b.2.2.x) comprises at least one aqueous polyurethane-polyurea dispersion (PD) comprising polyurethane-polyurea particles, where the polyurethane-polyurea particles present in the dispersion (PD) comprise anionic groups and/or groups which can be converted into anionic groups, and have an average particle size of 40 to 2000 nm and also a gel fraction of at least 50%.

The process stated above is also referred to below as process of the invention, and accordingly is a subject of the present invention. Preferred embodiments of the process of the invention can be found in the description later on below and also in the dependent claims.

A further subject of the present invention is a multicoat paint system produced using the process of the invention.

The process of the invention allows multicoat paint systems to be produced without a separate step of curing the coating film produced directly on the electrocoat. For greater ease of comprehension, this coating film is identified in the context of the present invention as basecoat film. Instead of separate curing, this basecoat film is jointly cured together with any further basecoat films beneath the clearcoat film, and with the clearcoat film. Nevertheless, through the application of the process of the invention, multicoat paint systems result that exhibit excellent stability with respect to pinholes. The overall appearance and the adhesion of these multicoat paint systems are outstanding as well and are situated at least at the level of multicoat paint systems produced by way of the above-described standard process.

### COMPREHENSIVE DESCRIPTION

First of all a number of terms used in the context of the present invention will be explained.

The application of a coating material to a substrate, and the production of a coating film on a substrate, are understood as follows. The coating material in question is applied such that the coating film produced therefrom is disposed on the substrate, but need not necessarily be in direct contact with the substrate. For example, between the coating film and the substrate, there may be other coats disposed. In stage (1), for example, the cured electrocoat (E.1) is produced on the metallic substrate (S), but between the substrate and the electrocoat there may also be a conversion coating disposed, as described later on below, such as a zinc phosphate coat.

The same principle applies to the application of a coating material (b) to a coating film (A) produced by means of another coating material (a), and to the production of a coating film (B) on another coating film (A). The coating film (B) need not necessarily be in contact with the coating film (A), being required merely to be disposed above it, in other words on the side of the coating film (A) that is remote from the substrate.

In contrast to this, the application of a coating material directly to a substrate, or the production of a coating film directly on a substrate, is understood as follows. The coating material in question is applied such that the coating film produced therefrom is disposed on the substrate and is in direct contact with the substrate. In particular, therefore, there is no other coat disposed between coating film and substrate.

The same applies, of course, to the application of a coating material (b) directly to a coating film (A) produced by means of another coating material (a), and to the production of a coating film (B) directly on another coating film (A). In this case the two coating films are in direct contact, being therefore disposed directly on one another. In particular there is no further coat between the coating films (A) and (B). The same principle of course applies to directly successive application of coating materials and to the production of directly successive coating films.

Flashing, interim drying, and curing are understood in the context of the present invention to have the same semantic content as that familiar to the skilled person in connection with processes for producing multicoat paint systems.

The term “flashing” is understood accordingly in principle as a designation for the passive or active evaporation of organic solvents and/or water from a coating material applied as part of the production of a paint system, usually at ambient temperature (that is, room temperature), 15 to 35° C. for example, for a duration of 0.5 to 30 minutes, for example. Flashing is accompanied therefore by evaporation of organic solvents and/or water present in the applied coating material. Since the coating material is still fluid, at any rate directly after application and at the beginning of flashing, it may flow in the course of flashing. The reason is that at least one coating material applied by spray application is applied generally in the form of droplets and not in a uniform thickness. As a result of the organic solvents and/or water it comprises, however, the material is fluid and may therefore undergo flow to form a homogeneous, smooth coating film. At the same time, there is successive evaporation of organic solvents and/or water, resulting after the flashing phase in a comparatively smooth coating film, which comprises less water and/or solvent in comparison with the applied coating material. After flashing, however, the coating film is not yet in the service-ready state. While it is no longer flowable, for example, it is still soft and/or tacky, and possibly is only partly dried. In particular, the coating film is not yet cured as described later on below.

Interim drying is thus understood likewise to refer to the passive or active evaporation of organic solvents and/or water from a coating material applied as part of the production of a paint system, usually at a temperature increased relative to the ambient temperature and amounting, for example, to 40 to 90° C., for a duration of 1 to 60 minutes, for example. In the course of interim drying as well, therefore, the applied coating material will lose a fraction of organic solvents and/or water. Based on a particular coating material, the general rule is that interim drying, by comparison with flashing, proceeds for example at higher temperatures and/or for a longer time period, meaning that, by comparison with flashing, there is also a higher fraction of organic solvents and/or water that escapes from the applied coating film. Even interim drying, however, does not result in a coating film in the service-ready state, in other words not a cured coating film as described later on below. A typical sequence of flashing and interim drying would be, for example, the flashing of an applied coating film at ambient temperature for 5 minutes and then its interim drying at 80° C. for 10 minutes. A conclusive delimitation of the two concepts from one another, however, is neither necessary nor desirable. For the sake of pure comprehension, these terms are used in order to make it clear that variable and sequential conditioning of a coating film can take place, prior to the curing described below. Here, depending on the coating material, the evaporation temperature and evaporation time, greater or lesser fractions of the organic solvents and/or water present in the coating material may evaporate. It is even possible here, optionally, for a fraction of the polymers present as binders in the coating material to undergo crosslinking or interlooping of one another as described below. Both in flashing and in interim drying, however, the kind of service-ready coating film that is the case for the curing described below is not obtained. Accordingly, curing is unambiguously delimited from flashing and interim drying.

The curing of a coating film is understood accordingly to be the conversion of such a film into the service-ready state, in other words into a state in which the substrate furnished with the coating film in question can be transported, stored, and used in its intended manner. A cured coating film, then, is in particular no longer soft or tacky, but instead is conditioned as a solid coating film which, even on further exposure to curing conditions as described later on below, no longer exhibits any substantial change in its properties such as hardness or adhesion to the substrate.

As is known, coating materials may in principle be cured physically and/or chemically, depending on components present such as binders and crosslinking agents. In the case of chemical curing, consideration is given to thermochemical curing and actinic-chemical curing. Where, for example, a coating material is thermochemically curable, it may be self-crosslinking and/or externally crosslinking. The indication that a coating material is self-crosslinking and/or externally crosslinking means, in the context of the present invention, that this coating material comprises polymers as binders and optionally crosslinking agents that are able to crosslink with one another correspondingly. The parent mechanisms and also binders and crosslinking agents that can be used are described later on below.

In the context of the present invention, “physically curable” or the term “physical curing” means the formation of a cured coating film by loss of solvent from polymer solutions or polymer dispersions, with the curing being achieved by interlooping of polymer chains. Coating materials of these kinds are generally formulated as one-component coating materials.

In the context of the present invention, “thermochemically curable” or the term “thermochemical curing” means the crosslinking of a coating film (formation of a cured coating film) initiated by chemical reaction of reactive functional groups, where the energetic activation of this chemical reaction is possible through thermal energy. Different functional groups which are complementary to one another can react with one another here (complementary functional groups), and/or the formation of the cured coat is based on the reaction of autoreactive groups, in other words functional groups which react among one another with groups of their own kind. Examples of suitable complementary reactive functional groups and autoreactive functional groups are known from German patent application DE 199 30 665 A1, page 7, line 28, to page 9, line 24, for example.

This crosslinking may be self-crosslinking and/or external crosslinking. Where, for example, the complementary reactive functional groups are already present in an organic polymer used as binder, as for example in a polyester, a polyurethane, or a poly(meth)acrylate, self-crosslinking obtains. External crosslinking obtains, for example, when a (first) organic polymer containing certain functional groups, hydroxyl groups for example, reacts with a crosslinking agent known per se, as for example with a polyisocyanate and/or a melamine resin. The crosslinking agent, then, contains reactive functional groups which are complementary to the reactive functional groups present in the (first) organic polymer used as binder.

In the case of external crosslinking in particular, the one-component and multicomponent systems, more particularly two-component systems, that are known per se are contemplated.

In thermochemically curable one-component systems, the components for crosslinking, as for example organic polymers as binders and crosslinking agents, are present alongside one another, in other words in one component. A requirement for this is that the components to be crosslinked react with one another—that is, enter into curing reactions—only at relatively high temperatures of more than 100° C., for example. Otherwise it would be necessary to store the components for crosslinking separately from one another and to mix them with one another only shortly before application to a substrate, in order to prevent premature at least proportional thermochemical curing (compare two-component systems). As an exemplary combination, mention may be made of hydroxy-functional polyesters and/or polyurethanes with melamine resins and/or blocked polyisocyanates as crosslinking agents.

In thermochemically curable two-component systems, the components that are to be crosslinked, as for example the organic polymers as binders and the crosslinking agents, are present separately from one another in at least two components, which are not combined until shortly before application. This form is selected when the components for crosslinking undergo reaction with one another even at ambient temperatures or slightly elevated temperatures of 40 to 90° C., for example. As an exemplary combination, mention may be made of hydroxy-functional polyesters and/or polyurethanes and/or poly(meth)acrylates with free polyisocyanates as crosslinking agent.

It is also possible for an organic polymer as binder to have both self-crosslinking and externally crosslinking functional groups, and to be then combined with crosslinking agents.

In the context of the present invention, “actinic-chemically curable”, or the term “actinic-chemical curing”, refers to the fact that the curing is possible with application of actinic radiation, this being electromagnetic radiation such as near infrared (NIR) and UV radiation, more particularly UV radiation, and also particulate radiation such as electron beams for curing. The curing by UV radiation is initiated customarily by radical or cationic photoinitiators. Typical actinically curable functional groups are carbon-carbon double bonds, with radical photoinitiators generally being employed in that case. Actinic curing, then, is likewise based on chemical crosslinking.

Of course, in the curing of a coating material identified as chemically curable, there will always be physical curing as well, in other words the interlooping of polymer chains. In this case, nevertheless, a coating material of this kind is identified as chemically curable.

It follows from the above that according to the nature of the coating material and the components it comprises, curing is brought about by different mechanisms, which of course also necessitate different conditions at the curing stage, more particularly different curing temperatures and curing times.

In the case of a purely physically curing coating material, curing takes place preferably between 15 and 90° C. over a period of 2 to 48 hours. In this case, then, the curing differs from the flashing and/or interim drying, where appropriate, solely in the duration of the conditioning of the coating film. Differentiation between flashing and interim drying, moreover, is not sensible. It would be possible, for example, for a coating film produced by application of a physically curable coating material to be subjected to flashing or interim drying first of all at 15 to 35° C. for a duration of 0.5 to 30 minutes, for example, and then to be cured at 50° C. for a duration of 5 hours.

Preferably, however, at least some of the coating materials for use in the context of the process of the invention, in other words electrocoat materials, aqueous basecoat materials, and clearcoat materials, are thermochemically curable, and especially preferably are thermochemically curable and externally crosslinking.

In principle, and in the context of the present invention, the curing of thermochemically curable one-component systems is carried out preferably at temperatures of 100 to 250° C., preferably 100 to 180° C., for a duration of 5 to 60 minutes, preferably 10 to 45 minutes, since these conditions are generally necessary in order for chemical crosslinking reactions to convert the coating film into a cured coating film. Accordingly it is the case that a flashing and/or interim drying phase taking place prior to curing takes place at lower temperatures and/or for shorter times. In such a case, for example, flashing may take place at to 35° C. for a duration of 0.5 to 30 minutes, for example, and/or interim drying may take place at a temperature of 40 to 90° C., for example, for a duration of 1 to 60 minutes, for example.

In principle, and in the context of the present invention, the curing of thermochemically curable two-component systems is carried out at temperatures of 15 to 90° C., for example, preferably 40 to 90° C., for a duration of 5 to 80 minutes, preferably 10 to 50 minutes. Accordingly it is the case that a flashing and/or interim drying phase occurring prior to curing takes place at lower temperatures and/or for shorter times. In such a case, for example, it is no longer sensible to make any distinction between the concepts of flashing and interim drying. A flashing or interim drying phase which precedes curing may take place, for example, at 15 to 35° C. for a duration of 0.5 to 30 minutes, for example, but any rate at lower temperatures and/or for shorter times than the curing that then follows.

This of course is not to rule out a thermochemically curable two-component system being cured at higher temperatures. For example, in step (4) of the process of the invention as described with more precision later on below, a basecoat film or two or more basecoat films are cured jointly with a clearcoat film. Where both thermochemically curable one-component systems and two-component systems are present within the films, such as a one-component basecoat material and a two-component clearcoat material, for example, the joint curing is of course guided by the curing conditions that are necessary for the one-component system.

All temperatures elucidated in the context of the present invention should be understood as the temperature of the room in which the coated substrate is located. It does not mean, therefore, that the substrate itself is required to have the temperature in question.

Where reference is made in the context of the present invention to an official standard, without indication of the official validity period, the reference is of course to the version of the standard valid on the filing date or, if there is no valid version at that date, the most recent valid version.

### THE PROCESS OF THE INVENTION

In the process of the invention, a multicoat paint system is built up on a metallic substrate (S).

Metallic substrates (S) contemplated essentially include substrates comprising or consisting of, for example, iron, aluminum, copper, zinc, magnesium, and alloys thereof, and also steel, in any of a very wide variety of forms and compositions. Preferred substrates are those of iron and steel, examples being typical iron and steel substrates as used in the automobile industry sector. The substrates themselves may be of whatever shape—that is, they may be, for example, simple metal panels or else complex components such as, in particular, automobile bodies and parts thereof.

Before stage (1) of the process of the invention, the metallic substrates (S) may be pretreated in a conventional way—that is, for example, cleaned and/or provided with known conversion coatings. Cleaning may be accomplished mechanically, for example, by means of wiping, sanding and/or polishing, and/or chemically by means of pickling methods, by incipient etching in acid or alkali baths, by means of hydrochloric or sulfuric acid, for example. Cleaning with organic solvents or aqueous cleaners is of course also possible. Pretreatment may likewise take place by application of conversion coatings, more particularly by means of phosphating and/or chromating, preferably phosphating. In any case, the metallic substrates are preferably conversion-coated, more particularly phosphatized, preferably provided with a zinc phosphate coat.

In stage (1) of the process of the invention, electrophoretic application of an electrocoat material (e.1) to the substrate (S) and subsequent curing of the electrocoat material (e.1) are used to produce a cured electrocoat (E.1) on the metallic substrate (S).

The electrocoat material (e.1) used in stage (1) of the process of the invention may be a cathodic or anodic electrocoat material. Preferably it is a cathodic electrocoat material. Electrocoat materials have long been known to the skilled person. They are aqueous coating materials comprising anionic or cationic polymers as binders. These polymers contain functional groups which are potentially anionic, meaning that they can be converted into anionic groups, carboxylic acid groups for example, or contain functional groups which are potentially cationic, meaning that they can be converted into cationic groups, amino groups for example. Conversion into charged groups is achieved generally through the use of corresponding neutralizing agents (organic amines (anionic), organic carboxylic acids such as formic acid (cationic)), with the anionic or cationic polymers then being produced as a result. The electrocoat materials generally and hence preferably further comprise typical anticorrosion pigments. The cathodic electrocoat materials that are preferred in the invention preferably comprise cationic polymers as binders, more particularly hydroxy-functional polyetheramines, which preferably have aromatic structural units. Such polymers are generally obtained by reaction of corresponding bisphenol-based epoxy resins with amines such as mono- and dialkylamines, alkanolamines and/or dialkylamino-alkylamines, for example. These polymers are used more particularly in combination with conventional blocked polyisocyanates. Reference may be made, by way of example, to the electrocoat materials described in WO 9833835 A1, WO 9316139 A1, WO 0102498 A1, and WO 2004018580 A1.

The electrocoat material (e.1) is therefore preferably an at any rate thermochemically curable coating material, and more particularly it is externally crosslinking. Preferably the electrocoat material (e.1) is a thermochemically curable one-component coating material. The electrocoat material (e.1) preferably comprises a hydroxy-functional epoxy resin as binder and a fully blocked polyisocyanate as crosslinking agent. The epoxy resin is preferably cathodic, more particularly containing amino groups.

Also known is the electrophoretic application of an electrocoat material (e.1) of this kind that takes place in stage (1) of the process of the invention. Application proceeds electrophoretically. This means that first of all the metallic workpiece for coating is immersed into a dipping bath comprising the coating material, and an electrical direct-current field is applied between the metallic workpiece and a counterelectrode. The workpiece therefore serves as the electrode; because of the described charge on the polymers used as binders, the nonvolatile constituents of the electrocoat material migrate through the electrical field to the substrate and are deposited on the substrate, producing an electrocoat film. In the case of a cathodic electrocoat material, for example, the substrate is connected accordingly as the cathode, and the hydroxide ions that form there as a result of the electrolysis of water carry out neutralization of the cationic binder, causing it to be deposited on the substrate and an electrocoat film to be formed. The process is therefore one of application by electrophoretic deposition.

Following the application of the electrocoat material (e.1), the coated substrate (S) is removed from the tank, optionally rinsed with water-based rinsing solutions, for example, then optionally subjected to flashing and/or interim drying, and lastly the applied electrocoat material is cured.

The applied electrocoat material (e.1) (or the applied, as yet uncured electrocoat film) is subjected to flashing at 15 to 35° C., for example, for a duration of 0.5 to 30 minutes, for example, and/or to interim drying at a temperature of preferably 40 to 90° C. for a duration of 1 to 60 minutes, for example.

The electrocoat material (e.1) applied to the substrate (or the applied, as yet uncured electrocoat film) is cured preferably at temperatures of 100 to 250° C., preferably 140 to 220° C., for a duration of 5 to 60 minutes, preferably 10 to 45 minutes, thereby producing the cured electrocoat (E.1).

The flashing, interim-drying, and curing conditions stated apply in particular to the preferred case where the electrocoat material (e.1) comprises a thermochemically curable one-component coating material as described above. This, however, does not rule out the electrocoat material being an otherwise-curable coating material and/or the use of different flashing, interim-drying, and curing conditions.

The film thickness of the cured electrocoat is, for example, 10 to 40 micrometers, preferably 15 to 25 micrometers. All film thicknesses reported in the context of the present invention should be understood as dry film thicknesses. It is therefore the thickness of the cured film in each case. Hence, where it is reported that a coating material is applied at a particular film thickness, this means that the coating material is applied in such a way as to result in the stated film thickness after curing.

In stage (2) of the process of the invention, (2.1) a basecoat film (B.2.1) is produced, or (2.2) two or more directly successive basecoat films (B.2.2.x) are produced. The films are produced by application (2.1) of an aqueous basecoat material (b.2.1) directly to the cured electrocoat (E.1), or by (2.2) directly successive application of two or more basecoat materials (b.2.2.x) to the cured electrocoat (E.1).

The directly successive application of two or more basecoat materials (b.2.2.x) to the cured electrocoat (E.1) therefore means that first of all a first basecoat material is applied directly to the electrocoat and thereafter a second basecoat material is applied directly to the film of the first basecoat material. An optional third basecoat material is then applied directly to the film of the second basecoat material. This procedure can then be repeated analogously for further basecoat materials (i.e., a fourth, fifth, etc. basecoat material).

After having been produced, therefore, the basecoat film (B.2.1) or the first basecoat film (B.2.2.x) is disposed directly on the cured electrocoat (E.1).

The terms basecoat material and basecoat film, in relation to the coating materials applied and coating films produced in stage (2) of the process of the invention, are used for greater ease of comprehension. The basecoat films (B.2.1) and (B.2.2.x) are not cured separately, but are instead cured jointly with the clearcoat material. Curing therefore takes place in analogy to the curing of basecoat materials employed in the standard process described in the introduction. In particular, the coating materials used in stage (2) of the process of the invention are not cured separately like the coating materials identified as surfacers in the standard process.

The aqueous basecoat material (b.2.1) used in stage (2.1) is described in detail later on below. In a first preferred embodiment, however, it is at any rate thermochemically curable, and with more particular preference is externally crosslinking. The basecoat material (b.2.1) here is preferably a one-component coating material. The basecoat material (b.2.1) here preferably comprises a combination of at least one hydroxy-functional polymer as binder, selected from the group consisting of polyurethanes, polyesters, polyacrylates, and copolymers of said polymers, examples being polyurethane-polyacrylates, and also of at least one melamine resin as crosslinking agent. This embodiment of the invention is especially appropriate when, for example, the multicoat paint system of the invention is to have extremely good glass bonding adhesion. The use of chemically curable basecoat materials means that the overall construction comprising multicoat paint system and layer of adhesion applied thereon is significantly more stable, and in particular does not rupture under mechanical tensile load within the paint system, such as within the basecoat, for example.

Equally possible depending on the sector of use, and hence a second preferred embodiment, however, is the use of basecoat materials (b.2.1) which comprise only small amounts of less than 5 wt %, preferably less than 2.5 wt %, based on the total weight of the basecoat material, of crosslinking agents such as, in particular, melamine resins. Further preferred in this embodiment is for there to be no crosslinking agents present at all. In spite of this, an outstanding quality is achieved within the overall construction. An additional advantage of not using crosslinking agents, and of the consequently lower complexity of the coating material, lies in the increase in the formulating freedom for the basecoat material. The shelf life as well may be better, owing to the avoidance of possible reactions on the part of the reactive components.

The basecoat material (b.2.1) may be applied by the methods known to the skilled person for applying liquid coating materials, as for example by dipping, knifecoating, spraying, rolling, or the like.

Preference is given to employing spray application methods, such as, for example, compressed air spraying (pneumatic application), airless spraying, high-speed rotation, electrostatic spray application (ESTA), optionally in conjunction with hot spray application such as hot air (hot spraying), for example. With very particular preference the basecoat material (b.2.1) is applied via pneumatic spray application or electrostatic spray application. Application of the basecoat material (b.2.1) accordingly produces a basecoat film (B.2.1), in other words a film of the basecoat material (b.2.1) that is applied directly on the electrocoat (E.1).

Following application, the applied basecoat material (b.2.1) or the corresponding basecoat film (B.2.1) is subjected to flashing at 15 to 35° C., for example, for a duration of 0.5 to 30 minutes, for example, and/or to interim drying at a temperature of preferably 40 to 90° C. for a duration of 1 to 60 minutes, for example. Preference is given to flashing initially at 15 to 35° C. for a duration of 0.5 to 30 minutes, followed by interim drying at 40 to 90° C. for a duration of 1 to 60 minutes, for example. The flashing and interim-drying conditions described are applicable in particular to the preferred case where the basecoat material (b.2.1) is a thermochemically curable one-component coating material. This does not, however, rule out the basecoat material (b.2.1) being an otherwise-curable coating material, and/or the use of different flashing and/or interim-drying conditions.

Within stage (2) of the process of the invention, the basecoat film (B.2.1) is not cured, i.e., is preferably not exposed to temperatures of more than 100° C. for a duration of longer than 1 minute, and more preferably is not exposed at all to temperatures of more than 100° C. This is a direct and clear consequence of stage (4) of the process of the invention, which is described later on below. Since the basecoat film is cured only in stage (4), it cannot already be cured in stage (2), since in that case curing in stage (4) would no longer be possible.

The aqueous basecoat materials (b.2.2.x) used in stage (2.2) of the process of the invention are also described in detail later below. In a first preferred embodiment, at least one of the basecoat materials used in stage (2.2) is at any rate thermochemically curable, and with more particular preference is externally crosslinking. More preferably this is so for all basecoat materials (b.2.2.x). Preference here is given to at least one basecoat material (b.2.2.x) being a one-component coating material, and even more preferably this is the case for all basecoat materials (b.2.2.x). Preferably here at least one of the basecoat materials (b.2.2.x) comprises a combination of at least one hydroxy-functional polymer as binder, selected from the group consisting of polyurethanes, polyesters, polyacrylates, and copolymers of the stated polymers, as for example polyurethane-polyacrylates, and also of at least one melamine resin as crosslinking agent. More preferably this is the case for all basecoat materials (b.2.2.x). This embodiment of the invention is appropriate in its turn when the aim is to achieve exceptionally good glass bonding adhesion.

Also possible and hence likewise a preferred embodiment, depending on area of application, however, is to use at least one basecoat material (b.2.2.x) which comprises only small amounts of less than 5 wt %, preferably less than 2.5 wt %, of crosslinking agents such as melamine resins in particular, based on the total weight of the basecoat material. Even more preferred in this embodiment is for there to be no crosslinking agents included at all. The aforesaid applies preferably to all of the basecoat materials (b.2.2.x) used. In spite of this, an outstanding quality is achieved in the overall system. Other advantages are freedom in formulation and stability in storage.

Basecoat materials (b.2.2.x) can be applied by the methods known to the skilled person for applying liquid coating materials, such as by dipping, knifecoating, spraying, rolling or the like, for example. Preference is given to employing spray application methods, such as, for example, compressed air spraying (pneumatic application), airless spraying, high-speed rotation, electrostatic spray application (ESTA), optionally in conjunction with hot spray application such as hot air (hot spraying), for example. With very particular preference the basecoat materials (b.2.2.x) are applied via pneumatic spray application and/or electrostatic spray application.

In stage (2.2) of the process of the invention, the following designation is appropriate. The basecoat materials and basecoat films are labeled generally as (b.2.2.x) and (B.2.2.x), whereas the x may be replaced by other letters which match accordingly when designating the specific individual basecoat materials and basecoat films.

The first basecoat material and the first basecoat film may be labeled with a; the topmost basecoat material and the topmost basecoat film may be labeled with z. These two basecoat materials and basecoat films are present in any case in stage (2.2). Any films between them may be given serial labeling as b, c, d and so on.

Through the application of the first basecoat material (b.2.2.a), accordingly, a basecoat film (B.2.2.a) is produced directly on the cured electrocoat (E.1). The at least one further basecoat film (B.2.2.x) is then produced directly on the basecoat film (B.2.2.a). Where two or more further basecoat films (B.2.2.x) are produced, they are produced in direct succession. For example, there may be exactly one further basecoat film (B.2.2.x) produced, in which case this film is disposed directly beneath the clearcoat film (K) in the multicoat paint system ultimately produced, and may therefore be termed basecoat film (B.2.2.z) (see also FIG. 2). Also possible, for example, is the production of two further basecoat films (B.2.2.x), in which case the film produced directly on the basecoat (B.2.2.a) may be designated as (B.2.2.b), and the film arranged lastly directly beneath the clearcoat film (K) may be designated in turn as (B.2.2.z) (see also FIG. 3).

The basecoat material (b.2.2.x) may be identical or different. It is also possible to produce two or more basecoat films (B.2.2.x) with the same basecoat material, and one or more further basecoat films (B.2.2.x) with one or more other basecoat materials.

The basecoat materials (b.2.2.x) applied are generally subjected, individually and/or with one another, to flashing and/or interim drying. In stage (2.2), preferably, flashing takes place at 15 to 35° C. for a duration of 0.5 to 30 min and interim drying takes place at 40 to 90° C. for a duration of 1 to 60 min, for example. The sequence of flashing and/or interim drying of individual or of two or more basecoat films (B.2.2.x) may be adapted according to the requirements of the case in hand. The above-described preferred flashing and interim-drying conditions apply particularly to the preferred case wherein at least one basecoat material (b.2.2.x), preferably all basecoat materials (b.2.2.x), comprises thermochemically curable one-component coating materials. This does not rule out, however, the basecoat materials (b.2.2.x) being coating materials which are curable in a different way, and/or the use of different flashing and/or interim-drying conditions.

If a first basecoat film is produced by applying a first basecoat material and a further basecoat film is produced by applying the same basecoat material, then obviously both films are based on the same basecoat material. But application, obviously, takes place in two stages, meaning that the basecoat material in question, in the sense of the process of the invention, corresponds to a first basecoat material (b.2.2.a) and a further basecoat material (b.2.2.z). The system described is also frequently referred to as a one-coat basecoat film system produced in two applications. Since, however, especially in real-life production-line (OEM) finishing, the technical circumstances in a finishing line always dictate a certain time span between the first application and the second application, during which the substrate, the automobile body, for example, is conditioned at 15 to 35° C., for example, and thereby flashed, it is formally clearer to characterize this system as a two-coat basecoat system. The operating regime described should therefore be assigned to the second variant of the process of the invention.

A number of preferred variants of the basecoat film sequences for the basecoat materials (b.2.2.x) may be elucidated as follows.

It is possible to produce a first basecoat film by, for example, electrostatic spray application (ESTA) of a first basecoat material directly on the cured drying thereon as described above, and subsequently to produce a second basecoat film by direct application of a second basecoat material, different from the first basecoat material. The second basecoat material may also be applied by electrostatic spray application, thereby producing a second basecoat film directly on the first basecoat film. Between and/or after the applications it is of course possible to carry out flashing and/or interim drying again. This variant of stage (2.2) is selected preferably when first of all a color-preparatory basecoat film, as described in more detail later on below, is to be produced directly on the electrocoat, and then a color- and/or effect-imparting basecoat film, as described in more detail later on below is to be produced directly on the first basecoat film. The first basecoat film in that case is based on the color-preparatory basecoat material, the second basecoat film on the color- and/or effect-imparting basecoat material. It is likewise possible, for example, to apply this second basecoat material as described above in two stages, thereby forming two further, directly successive basecoat films directly on the first basecoat film.

It is likewise possible for three basecoat films to be produced in direct succession directly on the cured electrocoat, with the basecoat films being based on three different basecoat materials. For example, a color-preparatory basecoat film, a further film based on a color- and/or effect-imparting basecoat material, and a further film based on a second color- and/or effect-imparting basecoat material may be produced.

Between and/or after the individual applications and/or after all three applications, it is possible in turn to carry out flashing and/or interim drying. Embodiments preferred in the context of the present invention therefore comprise the production in stage (2.2) of the process of the invention of two or three basecoat films. In that case it is preferred for the basecoat film produced directly on the cured electrocoat to be based on a color-preparatory basecoat material. The second and any third film are based either on one and the same color- and/or effect-imparting basecoat material, or on a first color- and/or effect-imparting basecoat material and on a different second color- and/or effect-imparting basecoat material. In one preferred variant, the basecoat materials which are applied to the film based on the color-preparatory basecoat material comprise in any case, but not necessarily exclusively, effect pigments and/or chromatic pigments. Chromatic pigments are part of the group of the color pigments, the latter also including achromatic color pigments such as black or white pigments.

Within stage (2) of the process of the invention, the basecoat films (B.2.2.x) are not cured—that is, they are preferably not exposed to temperatures of more than 100° C. for a duration of longer than 1 minute, and preferably not to temperatures of more than 100° C. at all. This is evident clearly and directly from stage (4) of the process of the invention, described later on below. Because the basecoat films are cured only in stage (4), they cannot be already cured in stage (2), since in that case the curing in stage (4) would no longer be possible.

The basecoat materials (b.2.1) and (b.2.2.x) are applied such that the basecoat film (B.2.1), and the individual basecoat films (B.2.2.x), after the curing has taken place in stage (4), have a film thickness of, for example 5 to 50 micrometers, preferably 6 to 40 micrometers, especially preferably 7 to 35 micrometers. In stage (2.1), preference is given to production of higher film thicknesses of 15 to 50 micrometers, preferably 20 to 45 micrometers. In stage (2.2), the individual basecoat films tend to have lower film thicknesses by comparison, the overall system then again having film thicknesses which lie within the order of magnitude of the one basecoat film (B.2.1). In the case of two basecoat films, for example, the first basecoat film (B.2.2.a) preferably has film thicknesses of 5 to 35, more particularly 10 to 30, micrometers, and the second basecoat film (B.2.2.z) preferably has film thicknesses of 5 to 35 micrometers, more particularly 10 to 30 micrometers, with the overall film thickness not exceeding 50 micrometers.

In stage (3) of the process of the invention, a clearcoat film (K) is produced directly (3.1) on the basecoat film (B.2.1) or (3.2) on the topmost basecoat film (B.2.2.z). This production is accomplished by corresponding application of a clearcoat material (k).

The clearcoat material (k) may be any desired transparent coating material known in this sense to the skilled person. “Transparent” means that a film formed with the coating material is not opaquely colored, but instead has a constitution such that the color of the underlying basecoat system is visible. As is known, however, this does not rule out the possible inclusion, in minor amounts, of pigments in a clearcoat material, such pigments possibly supporting the depth of color of the overall system, for example.

The coating materials in question are aqueous or solvent-containing transparent coating materials, which may be formulated not only as one-component but also as two-component or multicomponent coating materials. Also suitable, furthermore, are powder slurry clearcoat materials. Solventborne clearcoat materials are preferred.

The clearcoat materials (k) used may in particular be thermochemically curable and/or actinic-chemically curable. In particular they are thermochemically curable and externally crosslinking. Preference is given to thermochemically curable two-component clearcoat materials.

Typically and preferably, therefore, the clearcoat materials comprise at least one (first) polymer as binder, having functional groups, and at least one crosslinker having a functionality complementary to the functional groups of the binder. With preference at least one hydroxy-functional poly(meth)acrylate polymer is used as binder, and a free polyisocyanate as crosslinking agent.

Suitable clearcoat materials are described in, for example, WO 2006042585 A1, WO 2009077182 A1, or else WO 2008074490 A1.

The clearcoat material (k) is applied by the methods known to the skilled person for applying liquid coating materials, as for example by dipping, knifecoating, spraying, rolling, or the like. Preference is given to employing spray application methods, such as, for example, compressed air spraying (pneumatic application), and electrostatic spray application (ESTA).

The clearcoat material (k) or the corresponding clearcoat film (K) is subjected to flashing and/or interim-drying after application, preferably at 15 to 35° C. for a duration of 0.5 to 30 minutes. These flashing and interim-drying conditions apply in particular to the preferred case where the clearcoat material (k) comprises a thermochemically curable two-component coating material. But this does not rule out the clearcoat material (k) being an otherwise-curable coating material and/or other flashing and/or interim-drying conditions being used.

The clearcoat material (k) is applied in such a way that the clearcoat film after the curing has taken place in stage (4) has a film thickness of, for example, 15 to 80 micrometers, preferably 20 to 65 micrometers, especially preferably 25 to 60 micrometers.

In the process of the invention, of course, there is no exclusion of further coating materials, as for example further clearcoat materials, being applied after the application of the clearcoat material (k), and of further coating films, as for example further clearcoat films, being produced in this way. Such further coating films are then likewise cured in the stage (4) described below. Preferably, however, only the one clearcoat material (k) is applied, and is then cured as described in stage (4).

In stage (4) of the process of the invention there is joint curing (4.1) of the basecoat film (B.2.1) and of the clearcoat film (K) or (4.2) of the basecoat films (B.2.2.x) and of the clearcoat film (K).

The joint curing takes place preferably at temperatures of 100 to 250° C., preferably 100 to 180° C., for a duration of 5 to 60 minutes, preferably 10 to 45 minutes. These curing conditions apply in particular to the preferred case wherein the basecoat film (B.2.1) or at least one of the basecoat films (B.2.2.x), preferably all basecoat films (B.2.2.x), are based on a thermochemically curable one-component coating material. The reason is that, as described above, such conditions are generally required to achieve curing as described above for a one-component coating material of this kind. Where the clearcoat material (k), for example, is likewise a thermochemically curable one-component coating material, the corresponding clearcoat film (K) is of course likewise cured under these conditions. The same is evidently true of the preferred case wherein the clearcoat (k) is a thermochemically curable two-component coating material.

The statements made above, however, do not rule out the basecoat materials (b.2.1) and (b.2.2.x) and also the clearcoat materials (k) being otherwise-curable coating materials and/or other curing conditions being used.

The result after the end of stage (4) of the process of the invention is a multicoat paint system of the invention (see also FIGS. 1 to 3).

The Basecoat Materials for Inventive Use

The basecoat material (b.2.1) for use in accordance with the invention comprises at least one, preferably precisely one, specific aqueous polyurethane-polyurea dispersion (PD).

The polymer particles present in the dispersion are therefore polyurethane-polyurea-based. Such polymers are preparable in principle by conventional polyaddition of, for example, polyisocyanates with polyols and also polyamines. In view of the dispersion (PD) for inventive use and of the polymer particles present therein, however, there are specific conditions to be observed, which are elucidated below.

The polyurethane-polyurea particles present in the aqueous polyurethane-polyurea dispersion (PD) possess a gel fraction of at least 50% (for measurement method see Examples section). Moreover, the polyurethane-polyurea particles present in the dispersion (PD) possess an average particle size (also called mean particle size) of 40 to 2000 nanometers (nm) (for measurement method see Examples section).

The dispersions (PD) of the invention are therefore microgel dispersions. A microgel dispersion, indeed, as is known, is a polymer dispersion in which first the polymer is present in the form of comparatively small particles having sizes of, for example, 0.02 to 10 micrometers (“micro”-gel). Secondly, however, the polymer particles are at least partly intramolecularly crosslinked. The meaning of the latter phrase is that the polymer structures present within a particle equate to a typical macroscopic network with three-dimensional network structure. Viewed macroscopically, however, a microgel dispersion of this kind is still a dispersion of polymer particles in a dispersion medium, water for example. While the particles may also in part have crosslinking bridges to one another (this can hardly be ruled out not least owing to the production process), the system, however, at any rate is a dispersion with discrete particles present therein that have a measurable average particle size. In view of the molecular nature, however, these particles are dissolved in suitable organic solvents; macroscopic networks, in contrast, would only be swollen.

Since the microgels represent structures which lie between branched and macroscopically crosslinked systems, and consequently combine the characteristics of macromolecules with a network structure that are soluble in suitable organic solvents with those of insoluble macroscopic networks, the fraction of crosslinked polymers can only be determined, for example, after isolation of the solid polymer, by removal of water and any organic solvents, and subsequent extraction. The phenomenon exploited here is that whereby the microgel particles, originally soluble in suitable organic solvents, retain their internal network structure after isolation and behave in the solid form like a macroscopic network. Crosslinking can be verified via the experimentally obtainable gel fraction. The gel fraction ultimately is that portion of the polymer from the dispersion that, as an isolated solid, cannot be molecularly dispersely dissolved in a solvent. In this context it is necessary to rule out further increase in the gel fraction by subsequent crosslinking reactions during the isolation of the polymeric solid. This insoluble fraction corresponds in turn to the fraction of the polymer that is present in the dispersion in the form of intramolecularly crosslinked particles or particle fractions.

In the context of the present invention it has emerged that only microgel dispersions having polymer particles with sizes in the range essential to the invention have all of the requisite performance properties. An important factor in particular, therefore, is the combination of relatively low particle sizes with a nevertheless significant crosslink fraction or gel fraction. Only in this way is it possible to achieve the advantageous properties, especially the combination of good optical and mechanical properties of multicoat paint systems, on the one hand, and a high solids content and also good storage stability of aqueous basecoat materials, on the other. Thus, for example, dispersions having comparatively larger particles in the region of greater than 2 micrometers (average particle size), for example, exhibit increased sedimentation behavior and hence a poorer storage stability.

The polyurethane-polyurea particles present in the aqueous polyurethane-polyurea dispersion (PD) preferably possess a gel fraction of at least 60%, more preferably at least 70%, especially preferably at least 80%. The gel fraction may therefore amount to up to 100% or approximately 100%, as for example 99% or 98%. In such a case, then, the entire, or virtually the entire, polyurethane-polyurea polymer is in the form of crosslinked particles.

The polyurethane-polyurea particles present in the dispersion (PD) preferably possess an average particle size of 40 to 1500 nm, more preferably of 100 to 1000 nm, including preferably 110 to 500 nm and more preferably 120 to 300 nm. An especially preferred range lies from 130 to 250 nm.

The polyurethane-polyurea dispersion (PD) obtained is aqueous. The expression “aqueous” is known in this context to the skilled person. It refers fundamentally to a system which as its dispersion medium does not comprise exclusively or primarily organic solvents (also called solvents), but which, instead, includes a significant fraction of water as dispersion medium. Preferred embodiments of the aqueous character, defined via the maximum content of organic solvents and/or via the water content, are described later on below.

The polyurethane-polyurea particles comprise anionic groups and/or groups which can be converted into anionic groups (that is, groups which, through the use of known neutralizing agents, which are also identified later on below, such as bases, can be converted into anionic groups).

As the skilled person is aware, the groups in question here are, for example, carboxylic, sulfonic and/or phosphonic acid groups, especially preferably carboxylic acid groups (functional groups which can be converted into anionic groups by neutralizing agents), and also anionic groups derived from the aforementioned functional groups, such as, in particular, carboxylate, sulfonate and/or phosphonate groups, preferably carboxylate groups. A known effect of introducing such groups is to increase the dispersibility in water. Depending on conditions selected, the stated groups may be present proportionally or almost completely in the one form (carboxylic acid, for example) or the other form (carboxylate). A determining influencing factor is, for example, the use of the aforementioned neutralizing agents, of which further details are given in the description below. Irrespective of which form the stated groups have, however, a uniform nomenclature is often selected in the context of the present invention, for greater ease of comprehension. Where, for example, a particular acid number is reported for a polymer, or where a polymer is identified as carboxy-functional, the reference here is always to both the carboxylic acid groups and the carboxylate groups. If there is to be any differentiation in this respect, it is done, for example, using the degree of neutralization.

The stated groups can be introduced into polymers such as the polyurethane-polyurea particles, for example, via the known use of corresponding starting compounds when preparing the polymers. The starting compounds then comprise the groups in question, carboxylic acid groups for example, and are copolymerized into the polymer via further functional groups, hydroxyl groups for example. More extensive details are described later on below.

Preferred anionic groups and/or groups which can be converted into anionic groups are carboxylate groups and carboxylic acid groups, respectively. Based on the solids content, the polyurethane-polyurea polymer present in particle form in the dispersion preferably possesses an acid number of 10 to 35 mg KOH/g, more particularly of 15 to 23 mg KOH/g (for measurement method see Examples section).

The polyurethane-polyurea particles present in the dispersion (PD) preferably comprise, in each case in reacted form, (Z.1.1) at least one polyurethane prepolymer containing isocyanate groups and comprising anionic groups and/or groups which can be converted into anionic groups, and also (Z.1.2) at least one polyamine comprising two primary amino groups and one or two secondary amino groups.

Where it is stated in the context of the present invention that polymers, such as the polyurethane-polyurea particles of the dispersion (PD), for example, comprise particular components in reacted form, this means that these particular components are used as starting compounds in the preparation of the polymers in question. Depending on the nature of the starting compounds, the particular reaction to give the target polymer take place according to different mechanisms. Evidently, then, in the preparation of polyurethane-polyurea particles or polyurethane-polyurea polymers, the components (Z.1.1) and (Z.1.2) are reacted with one another through reaction of the isocyanate groups of (Z.1.1) with the amino groups of (Z.1.2) to form urea bonds. The polymer then of course comprises the amino groups and isocyanate groups, present beforehand, in the form of urea groups—that is, in their correspondingly reacted form. Ultimately, nevertheless, the polymer comprises the two components (Z.1.1) and (Z.1.2), since aside from the reacted isocyanate groups and amino groups, the components remain unchanged. For ease of comprehension, accordingly, it is said that the polymer in question comprises the components, in each case in reacted form. The meaning of the expression “the polymer comprises a component (X) in reacted form” can therefore be equated with the meaning of the expression “in the preparation of the polymer, component (X) was used”.

It follows from the above that anionic groups and/or groups which can be converted into anionic groups are introduced into the polyurethane-polyurea particles preferably by way of the abovementioned polyurethane prepolymer containing isocyanate groups.

The polyurethane-polyurea particles preferably consist of the two components (Z.1.1) and (Z.1.2)—that is, they are prepared from these two components.

The aqueous dispersion (PD) can be, and preferably is, obtained by a specific three-stage process. As part of the description of this process, preferred embodiments of the components (Z.1.1) and (Z.1.2) are stated as well.

The process comprises

(I)

preparing a composition (Z) comprising, based in each case on the total amount of the composition (Z),

(Z.1) 15 to 65 wt % of at least one intermediate containing isocyanate groups and having blocked primary amino groups, prepared through the reaction

(Z.1.1) of at least one polyurethane prepolymer containing isocyanate groups and comprising anionic groups and/or groups which can be converted into anionic groups, with

(Z.1.2a) at least one polyamine comprising two blocked primary amino groups and one or two free secondary amino groups

by addition reaction of isocyanate groups (Z.1.1) with free secondary amino groups from (Z.1.2),

(Z.2) 35 to 85 wt % of at least one organic solvent which has a solubility in water at a temperature of 20° C. of not more than 38 wt %,

(II)

dispersing the composition (Z) in aqueous phase, and

(III)

at least partly removing the at least one organic solvent (Z.2) from the dispersion obtained in (II).

In the first step (I) of this process, then, a specific composition (Z) is prepared.

The composition (Z) comprises at least one, preferably precisely one, specific isocyanate group-containing intermediate (Z.1) having blocked primary amino groups.

The preparation of the intermediate (Z.1) comprises the reaction of at least one polyurethane prepolymer (Z.1.1) containing isocyanate groups and comprising anionic groups and/or groups which can be converted into anionic groups, with at least one polyamine (Z.1.2a) that is derived from a polyamine (Z.1.2) and that comprises at least two blocked primary amino groups and at least one free secondary amino group.

Polyurethane polymers containing isocyanate groups and comprising anionic groups and/or groups which can be converted into anionic groups are known in principle. In the context of the present invention, for greater ease of comprehension, the component (Z.1.1) is referred to as prepolymer. This is because it is a polymer to be identified as a precursor, being used as a starting component for the preparation of another component, namely the intermediate (Z.1).

For the preparation of the polyurethane prepolymers (Z.1.1) containing isocyanate groups and comprising anionic groups and/or groups which can be converted into anionic groups, it is possible to use the aliphatic, cycloaliphatic, aliphatic-cycloaliphatic, aromatic, aliphatic-aromatic and/or cycloaliphatic-aromatic polyisocyanates that are known to the skilled person. Preference is given to using diisocyanates. The following diisocyanates may be stated by way of example: 1,3- or 1,4-phenylene diisocyanate, 2,4- or 2,6-tolylene diisocyanate, 4,4′- or 2,4′-diphenyl-methane diisocyanate, 1,4- or 1,5-naphthylene diisocyanate, diisocyanatodiphenyl ether, trimethylene diisocyanate, tetramethylene diisocyanate, ethylethylene diisocyanate, 2,3-dimethylethylene diisocyanate, 1-methyltrimethylene diisocyanate, pentamethylene diisocyanate, 1,3-cyclopentylene diisocyanate, hexamethylene diisocyanate, cyclohexylene diisocyanate, 1,2-cyclohexylene diisocyanate, octamethylene diisocyanate, trimethylhexane diisocyanate, tetramethylhexane diisocyanate, decamethylene diisocyanate, dodecamethylene diisocyanate, tetradecamethylene diisocyanate, isophorone diisocyanate (IPDI), 2-isocyanato-propyl-cyclohexyl isocyanate, dicyclohexylmethane 2,4′-diisocyanate, dicyclohexylmethane 4,4′-diisocyanate, 1,4- or 1,3-bis(isocyanatomethyl)cyclohexane, 1,4- or 1,3- or 1,2-diisocyanatocyclohexane, 2,4- or 2,6-di-isocyanato-1-methylcyclohexane, 1-isocyanatomethyl-5-isocyanato-1,3,3-trimethylcyclohexane, 2,3-bis(8-iso-cyanatooctyl)-4-octyl-5-hexylcyclohexene, tetramethylxylylene diisocyanates (TMXDI) such as m-tetramethylxylylene diisocyanate, or mixtures of these polyisocyanates. Also possible, of course, is the use of different dimers and trimers of the stated diisocyanates such as uretdiones and isocyanurates. Use may also be made of polyisocyanates of higher isocyanate functionality. Examples thereof are tris(4-isocyanatophenyl)methane, 1,3,4-triisocyanatobenzene, 2,4,6-triisocyanatotoluene, 1,3,5-tris(6-isocyanato-hexylbiurete), bis-(2,5-diisocyanato-4-methylphen-yl)methane. The functionality may optionally be lowered by reaction with monoalcohols and/or secondary amines. Preference, however, is given to the use of diisocyanates, more preferably to the use of aliphatic diisocyanates, such as hexamethylene diisocyanate, isophorone diisocyanate (IPDI), dicyclohexylmethane 4,4′-diisocyanate, 2,4- or 2,6-diisocyanato-1-methylcyclohexane, and m-tetramethylxylylene diisocyanate (m-TMXDI). An isocyanate is termed aliphatic when the isocyanate groups are attached to aliphatic groups, in other words there is no aromatic carbon in alpha-position to an isocyanate group.

For the preparation of the prepolymers (Z.1.1), the polyisocyanates are reacted with polyols, more particularly diols, generally with formation of urethanes.

Examples of suitable polyols are saturated or olefinically unsaturated polyester polyols and/or polyether polyols. Used in particular as polyols are polyester polyols, especially those having a number-average molecular weight of 400 to 5000 g/mol (for measurement method see Examples section). Polyester polyols, preferably polyester diols, of this kind may be prepared in a known way by reaction of corresponding polycarboxylic acids, preferably dicarboxylic acids, and/or their anhydrides, with corresponding polyols, preferably diols, by esterification. Of course it is also possible optionally, additionally, to make proportional use of monocarboxylic acids and/or monoalcohols for the preparation procedure. The polyester diols are preferably saturated, more particularly saturated and linear.

Examples of suitable aromatic polycarboxylic acids for the preparation of such polyester polyols, preferably polyester diols, are phthalic acid, isophthalic acid, and terephthalic acid, of which isophthalic acid is advantageous and is therefore used with preference. Examples of suitable aliphatic polycarboxylic acids are oxalic acid, malonic acid, succinic acid, glutaric acid, adipic acid, pimelic acid, suberic acid, azelaic acid, sebacic acid, undecanedicarboxylic acid, and dodecanedicarboxylic acid, or else hexahydrophthalic acid, 1,3-cyclohexanedicarboxylic acid, 1,4-cyclohexanedicarboxylic acid, 4-methylhexahydrophthalic acid, tricyclodecanedicarboxylic acid, and tetra-hydrophthalic acid. As dicarboxylic acids it is likewise possible to use dimer fatty acids, or dimerized fatty acids, which, as is known, are mixtures prepared by dimerization of unsaturated fatty acids and are available under the trade names Radiacid (from Oleon) or Pripol (from Croda), for example. Using dimer fatty acids of these kinds to prepare polyester diols is preferred in the context of the present invention. Polyols used with preference for preparing the prepolymers (Z.1.1) are therefore polyester diols which have been prepared using dimer fatty acids. Especially preferred are those polyester diols in whose preparation at least 50 wt %, preferably 55 to 75 wt %, of the dicarboxylic acids used are dimer fatty acids.

Examples of corresponding polyols for the preparation of polyester polyols, preferably polyester diols, are ethylene glycol, 1,2-, or 1,3-propanediol, 1,2-, 1,3-, or 1,4-butanediol, 1,2-, 1,3-, 1,4-, or 1,5-pentanediol, 1,2-, 1,3-, 1,4-, 1,5-, or 1,6-hexanediol, neopentyl hydroxypivalate, neopentyl glycol, diethylene glycol, 1,2-, 1,3-, or 1,4-cyclohexanediol, 1,2-, 1,3-, or 1,4-cyclohexanedimethanol, and trimethylpentanediol. Preference is therefore given to using diols. Such polyols or diols may of course also be used directly to prepare the prepolymer (Z.1.1), in other words reacted directly with polyisocyanates.

For preparing the prepolymers (Z.1.1) it is also possible, furthermore, to use polyamines such as diamines and/or amino alcohols. Examples of diamines include hydrazine, alkyl- or cycloalkyldiamines such as propylenediamine and 1-amino-3-aminomethyl-3,5,5-trimethylcyclohexane, and examples of amino alcohols include ethanolamine or diethanolamine.

The prepolymers (Z.1.1) comprise anionic groups and/or groups which can be converted into anionic groups. For the purpose of introducing said groups it is possible, during the preparation of the prepolymers (Z.1.1), to use starting compounds which as well as groups for reaction in the production of urethane bonds, preferably hydroxyl groups, further comprise the abovementioned groups, carboxylic acid groups for example. In this way the groups in question are introduced into the prepolymer.

Corresponding compounds contemplated for introducing the preferred carboxylic acid groups are—insofar as they contain carboxyl groups—polyether polyols and/or polyester polyols. Preference, however, is given to using compounds that are at any rate of low molecular mass, and that have at least one carboxylic acid group and at least one functional group which is reactive toward isocyanate groups, hydroxyl groups being preferred. The expression “low molecular mass compound” for the purposes of the present invention means that in contrast to compounds of relatively high molecular mass, more particularly polymers, the compounds in question are those which can be assigned a discrete molecular weight, as preferably monomeric compounds. A low molecular mass compound, then, is in particular not a polymer, since the latter always constitute a mixture of molecules and must be described using average molecular weights. The term “low molecular mass compound” means preferably that the compounds in question have a molecular weight of less than 300 g/mol. The range from 100 to 200 g/mol is preferred.

Compounds preferred in this sense are, for example, monocarboxylic acids comprising two hydroxyl groups, such as dihydroxypropionic acid, dihydroxysuccinic acid, and dihydroxybenzoic acid, for example. Very particular are alpha,alpha-dimethylolalkanoic acids such as 2,2-dimethylolacetic acid, 2,2-dimethylolpropionic acid, 2,2-dimethylolbutyric acid, and 2,2-dimethylolpentanoic acid, especially 2,2-dimethylolpropionic acid.

The prepolymers (Z.1.1) are therefore preferably carboxy-functional. Based on the solids content, they possess an acid number of preferably 10 to 35 mg KOH/g, more particularly 15 to 23 mg KOH/g.

The number-average molecular weight of the prepolymers may vary widely and is situated for example in the range from 2000 to 20 000 g/mol, preferably from 3500 to 6000 g/mol (for measurement method see Examples section).

The prepolymer (Z.1.1) contains isocyanate groups. Based on the solids content, it preferably possesses an isocyanate content of 0.5 to 6.0 wt %, preferably 1.0 to 5.0 wt %, especially preferably 1.5 to 4.0 wt % (for measurement method see Example section).

Since the prepolymer (Z.1.1) contains isocyanate groups, the hydroxyl number of the prepolymer will obviously be very low as a general rule. The hydroxyl number of the prepolymer, based on the solids content, is preferably less than 15 mg KOH/g, more particularly less than 10 mg KOH/g, and with further preference less than 5 mg KOH/g (for measurement method see Examples section).

The prepolymers (Z.1.1) may be prepared by known and established methods in bulk or in solution, especially preferably by reaction of the starting compounds in organic solvents, such as methyl ethyl ketone for preference, at temperatures of, for example, 60 to 120° C., and optionally with use of catalysts typical for polyurethane preparation. Such catalysts are known to the skilled person; an example is dibutyltin laurate. The procedure here is of course to select the ratio of the starting components such that the product—that is, the prepolymer (Z.1.1)—comprises isocyanate groups. It is likewise immediately apparent that the solvents ought to be selected such that they do not enter into any unwanted reactions with the functional groups of the starting compounds, in other words being inert with respect to these groups to an extent such that they do not hinder the reaction of these functional groups. The preparation is preferably carried out already in an organic solvent (Z.2) as described later on below, since this solvent is required in any case to be present in the composition (Z) to be prepared in stage (I) of the process.

As is already indicated above, the groups which are present in the prepolymer (Z.1.1) and which can be converted into anionic groups may also be present proportionally as correspondingly anionic groups, as a result of the use of a neutralizing agent, for example. In this way it is possible to adjust the water-dispersibility of the prepolymers (Z.1.1) and hence also of the intermediate (Z.1).

Neutralizing agents contemplated include, in particular, the known basic neutralizing agents such as, for example, carbonates, hydrogencarbonates, or hydroxides of alkali metals and alkaline earth metals, such as LiOH, NaOH, KOH, or Ca(OH)₂, for example. Likewise suitable for neutralization and used with preference in the context of the present invention are organic bases containing nitrogen, such as amines such as ammonia, trimethylamine, triethylamine, tributylamines, dimethylaniline, triphenylamine, dimethylethanolamine, methyldiethanolamine, or triethanolamine, and also mixtures thereof.

The neutralization of the prepolymer (Z.1.1) with the neutralizing agents, more particularly with the organic bases containing nitrogen, may take place after the preparation of the prepolymer in organic phase, in other words in solution with an organic solvent, more particularly with a solvent (Z.2) as described below. The neutralizing agent may of course also be added as early as during or before the start of the actual polymerization, in which case, for example, the starting compounds containing carboxylic acid groups are then neutralized.

If neutralization is desired for the groups which can be converted into anionic groups, more particularly for the carboxylic acid groups, the neutralizing agent may be added, for example, in an amount such that a fraction of 35% to 65% of the groups is neutralized (degree of neutralization). Preferred is a range from 40% to 60% (for calculation method see Examples section).

It is preferred for the prepolymer (Z.1.1) to be neutralized after its preparation and before its use for the preparation of the intermediate (Z.1), as described.

The herein-described preparation of the intermediate (Z.1) encompasses the reaction of the described prepolymer (Z.1.1) with at least one, preferably precisely one, polyamine (Z.1.2a) derived from a polyamine (Z.1.2).

The polyamine (Z.1.2a) comprises two blocked primary amino groups and one or two free secondary amino groups.

Blocked amino groups, as is known, are those in which the hydrogen radicals on the nitrogen, that are present inherently in free amino groups, are substituted by reversible reaction with a blocking agent. By virtue of the blocking, the amino groups cannot be reacted, as can free amino groups, by condensation or addition reactions, and in this respect are therefore unreactive and hence differ from free amino groups. Only the removal of the reversibly adducted blocking agent again, thereby restoring the free amino groups, then allows, obviously, the conventional reactions of the amino groups. The principle therefore resembles the principle of masked or blocked isocyanates, which are likewise known within the field of polymer chemistry.

The primary amino groups of the polyamine (Z.1.2a) may be blocked with the conventional blocking agents, such as with ketones and/or aldehydes, for example. Such blocking then produces, with release of water, ketimines and/or aldimines, which no longer contain any nitrogen-hydrogen bonds, thereby preventing any typical condensation or addition reactions of an amino group with another functional group such as an isocyanate group.

Reaction conditions for preparing a blocked primary amine of this kind, such as a ketimine, for example, are known. Thus, for example, such blocking may be realized with supply of heat to a mixture of a primary amine with an excess of a ketone that functions simultaneously as a solvent for the amine. The water of reaction produced is preferably removed during the reaction, in order to prevent the otherwise possible reverse reaction (deblocking) of the reversible blocking.

The reaction conditions for the deblocking of blocked primary amino groups are also known per se. Thus, for example, the simple transfer of a blocked amine to the aqueous phase is sufficient for the equilibrium to be shifted back to the side of deblocking, as a result of the concentration pressure then exerted by the water, and so to produce free primary amino groups and also a free ketone, with consumption of water.

It follows from what has been said above that a clear distinction is made in the context of the present invention between blocked and free amino groups. Where, however, an amino group is specified neither as blocked nor as free, the reference is to a free amino group.

Preferred blocking agents for blocking the primary amino groups of the polyamine (Z.1.2a) are ketones. Among the ketones, particular preference is given to those which constitute an organic solvent (Z.2) as described later on below. The reason is that these solvents (Z.2) must in any case be present in the composition (Z) to be prepared in stage (I) of the process. It has already been indicated above that the preparation of such primary amines blocked with a ketone is accomplished to particularly good effect in an excess of the ketone. Through the use of ketones (Z.2) for the blocking, therefore, it is possible to employ the correspondingly preferred preparation procedure for blocked amines, without any need for costly and inconvenient removal of the possibly unwanted blocking agent. Instead, the solution of the blocked amine can be used directly to prepare the intermediate (Z.1). Preferred blocking agents are acetone, methyl ethyl ketone, methyl isobutyl ketone, diisopropyl ketone, cyclopentanone, or cyclohexanone; particularly preferred are the (Z.2) ketones methyl ethyl ketone and methyl isobutyl ketone.

The preferred blocking with ketones and/or aldehydes, especially ketones, and the accompanying preparation of ketimines and/or aldimines, moreover, has the advantage that primary amino groups selectively are blocked. Secondary amino groups present can obviously not be blocked, and therefore remain free. Accordingly it is possible to prepare a polyamine (Z.1.2a) which as well as the two blocked primary amino groups also comprises one or two free secondary amino groups in a trouble-free way via the stated preferred blocking reactions from a polyamine (Z.1.2) which comprises free secondary and primary amino groups.

The polyamines (Z.1.2a) may be prepared by blocking the primary amino groups of polyamines (Z.1.2) comprising two primary amino groups and one or two secondary amino groups. Suitable ultimately are all conventional aliphatic, aromatic, or araliphatic (mixed aliphatic-aromatic) polyamines (Z.1.2) having two primary amino groups and one or two secondary amino groups. This means that as well as the stated amino groups, there may be inherently arbitrary aliphatic, aromatic, or araliphatic groups present. Possible examples include monovalent groups, arranged as terminal groups on a secondary amino group, or divalent groups, arranged between two amino groups.

Organic groups are considered aliphatic in the context of the present invention if they are not aromatic. For example, the groups present in addition to the stated amino groups may be aliphatic hydrocarbon groups, these being groups which consist exclusively of carbon and hydrogen and are not aromatic. These aliphatic hydrocarbon groups may be linear, branched or cyclic, and may be saturated or unsaturated. These groups, of course, may also comprise cyclic and linear or branched components. A further possibility is for aliphatic groups to include heteroatoms, especially in the form of bridging groups such as ether, ester, amide and/or urethane groups. Possible aromatic groups are likewise known and require no further elucidation.

The polyamines (Z.1.2a) preferably possess two blocked primary amino groups and one or two free secondary amino groups, and they preferably possess, as primary amino groups, exclusively blocked primary amino groups and, as secondary amino groups, exclusively free secondary amino groups.

In total the polyamines (Z.1.2a) preferably possess three or four amino groups, these groups being selected from the group of the blocked primary amino groups and of the free secondary amino groups.

Especially preferred polyamines (Z.1.2a) are those which consist of two blocked primary amino groups, one or two free secondary amino groups, and also aliphatic-saturated hydrocarbon groups.

Analogous preferred embodiments are valid for the polyamines (Z.1.2), which then contain free primary amino groups rather than blocked primary amino groups.

Examples of preferred polyamines (Z.1.2) from it is also possible, by blocking of the primary amino groups, to prepare polyamines (Z.1.2a) are diethylenetriamine, 3-(2-aminoethyl)aminopropylamine, dipropylenetriamine, and also N1-(2-(4-(2-aminoethyl)piperazin-1-yl)ethyl)ethane-1,2-diamine (one secondary amino group, two primary amino groups for blocking) and triethylenetetramine, and also N,N′-bis(3-aminopropyl)-ethylenediamine (two secondary amino groups, two primary amino groups for blocking).

To the skilled person it is clear that not least for reasons associated with pure technical synthesis, there cannot always be a theoretically idealized quantitative conversion in the blocking of primary amino groups. For example, if a particular amount of a polyamine is blocked, the proportion of the primary amino groups that are blocked in the blocking process may be, for example, 95 mol % or more (determinable by IR spectroscopy; see Examples section). Where a polyamine in the nonblocked state, for example, possesses two free primary amino groups, and where the primary amino groups of a certain quantity of this amine are then blocked, it is said in the context of the present invention that this amine has two blocked primary amino groups if a fraction of more than 95 mol % of the primary amino groups present in the quantity employed are blocked. This is due on the one hand to the fact, already stated, that from a technical synthesis standpoint, a quantitative conversion cannot always be realized. On the other hand, the fact that more than 95 mol % of the primary amino groups are blocked means that the major fraction of the total amount of the amines used for blocking does in fact contain exclusively blocked primary amino groups, specifically exactly two blocked primary amino groups.

The preparation of the intermediate (Z.1) involves the reaction of the prepolymer (Z.1.1) with the polyamine (Z.1.2) by addition reaction of isocyanate groups from (Z.1.1) with free secondary amino groups from (Z.1.2). This reaction, which is known per se, then leads to the attachment of the polyamine (Z.1.2a) onto the prepolymer (Z.1.1), with formation of urea bonds, ultimately forming the intermediate (Z.1). It will be readily apparent that in the preparation of the intermediate (Z.1), preference is thus given to not using any other amines having free or blocked secondary or free or blocked primary amino groups.

The intermediate (Z.1) can be prepared by known and established techniques in bulk or solution, especially preferably by reaction of (Z.1.1) with (Z.1.2a) in organic solvents. It is immediately apparent that the solvents ought to be selected in such a way that they do not enter into any unwanted reactions with the functional groups of the starting compounds, and are therefore inert or largely inert in their behavior toward these groups. As solvent in the preparation, preference is given to using, at least proportionally, an organic solvent (Z.2) as described later on below, especially methyl ethyl ketone, even at this stage, since this solvent must in any case be present in the composition (Z) to be prepared in stage (I) of the process. With preference a solution of a prepolymer (Z.1.1) in a solvent (Z.2) is mixed here with a solution of a polyamine (Z.1.2) in a solvent (Z.2), and the reaction described can take place.

Of course, the intermediate (Z.1) thus prepared may be neutralized during or after the preparation, using neutralizing agents already described above, in the manner likewise described above for the prepolymer (Z.1.1). It is nevertheless preferred for the prepolymer (Z.1.1) to be already neutralized prior to its use for preparing the intermediate (Z.1), in a manner described above, so that neutralization during or after the preparation of (Z.1) is no longer relevant. In such a case, therefore, the degree of neutralization of the prepolymer (Z.1.1) can be equated with the degree of neutralization of the intermediate (Z.1). So where there is no further addition of neutralizing agents at all in the context of the process, accordingly, the degree of neutralization of the polymers present in the ultimately prepared dispersions (PD) of the invention can also be equated with the degree of neutralization of the prepolymer (Z.1.1).

The intermediate (Z.1) possesses blocked primary amino groups. This can evidently be achieved in that the free secondary amino groups are brought to reaction in the reaction of the prepolymer (Z.1.1) and of the polyamine (Z.1.2a), but the blocked primary amino groups are not reacted. Indeed, as already described above, the effect of the blocking is that typical condensation reactions or addition reactions with other functional groups, such as isocyanate groups, are unable to take place. This of course means that the conditions for the reaction should be selected such that the blocked amino groups also remain blocked, in order thereby to provide an intermediate (Z.1). The skilled person knows how to set such conditions, which are brought about, for example, by reaction in organic solvents, which is preferred in any case.

The intermediate (Z.1) contains isocyanate groups. Accordingly, in the reaction of (Z.1.1) and (Z.1.2a), the ratio of these components must of course be selected such that the product—that is, the intermediate (Z.1)—contains isocyanate groups.

Since, as described above, in the reaction of (Z.1.1) with (Z.1.2), free secondary amino groups are reacted with isocyanate groups, but the primary amino groups are not reacted, owing to the blocking, it is thus first of all immediately clear that in this reaction the molar ratio of isocyanate groups from (Z.1.1) to free secondary amino groups from (Z.1.2) must be greater than 1. This feature arises implicitly, nevertheless clearly and directly from the feature essential to the invention, namely that the intermediate (Z.1) contains isocyanate groups.

It is nevertheless preferred for there to be an excess of isocyanate groups, defined as below, during the reaction. The molar amounts (n) of isocyanate groups, free secondary amino groups, and blocked primary amino groups, in this preferred embodiment, satisfy the following condition: [n (isocyanate groups from (Z.1.1))−n (free secondary amino groups from (Z.1.2))]/n (blocked primary amino groups from (Z.1.2a))=1.2/1 to 4/1, preferably 1.5/1 to 3/1, very preferably 1.8/1 to 2.2/1, even more preferably 2/1.

In these preferred embodiments, the intermediate (Z.1), formed by reaction of isocyanate groups from (Z.1.1) with the free secondary amino groups from (Z.1.2a), possesses an excess of isocyanate groups in relation to the blocked primary amino groups. This excess is ultimately achieved by selecting the molar ratio of isocyanate groups from (Z.1.1) to the total amount of free secondary amino groups and blocked primary amino groups from (Z.1.2a) to be large enough that even after the preparation of (Z.1) and the corresponding consumption of isocyanate groups by the reaction with the free secondary amino groups, there remains a corresponding excess of the isocyanate groups.

Where, for example, the polyamine (Z.1.2a) has one free secondary amino group and two blocked primary amino groups, the molar ratio between the isocyanate groups from (Z.1.1) to the polyamine (Z.1.2a) in the very especially preferred embodiment is set at 5/1. The consumption of one isocyanate group in the reaction with the free secondary amino group would then mean that 4/2 (or 2/1) is realized for the condition stated above.

The fraction of the intermediate (Z.1) is from 15 to 65 wt %, preferably from 25 to 60 wt %, more preferably from 30 to 55 wt %, especially preferably from 35 to 52.5 wt %, and, in one very particular embodiment, from 40 to 50 wt %, based in each case on the total amount of the composition (Z).

Determining the fraction of an intermediate (Z.1) may be carried out as follows: The solids content of a mixture which besides the intermediate (Z.1) contains only organic solvents is ascertained (for measurement method for determining the solids (also called solids content, see Examples section). The solids content then corresponds to the amount of the intermediate (Z.1). By taking account of the solids content of the mixture, therefore, it is possible to determine or specify the fraction of the intermediate (Z.1) in the composition (Z). Given that the intermediate (Z.1) is preferably prepared in an organic solvent anyway, and therefore, after the preparation, is in any case present in a mixture which comprises only organic solvents apart from the intermediate, this is the technique of choice.

The composition (Z) further comprises at least one specific organic solvent (Z.2).

The solvents (Z.2) possess a solubility in water of not more than 38 wt % at a temperature of 20° C. (for measurement method, see Examples section). The solubility in water at a temperature of 20° C. is preferably less than 30 wt %. A preferred range is from 1 to 30 wt %.

The solvent (Z.2) accordingly possesses a fairly moderate solubility in water, being in particular not fully miscible with water or possessing no infinite solubility in water. A solvent is fully miscible with water when it can be mixed in any proportions with water without occurrence of separation, in other words of the formation of two phases.

Examples of solvents (Z.2) are methyl ethyl ketone, methyl isobutyl ketone, diisobutyl ketone, diethyl ether, dibutyl ether, dipropylene glycol dimethyl ether, ethylene glycol diethyl ether, toluene, methyl carbonate, cyclohexanone, or mixtures of these solvents. Preference is given to methyl ethyl ketone, which has a solubility in water of 24 wt % at 20° C.

No solvents (Z.2) are therefore solvents such as acetone, N-methyl-2-pyrrolidone, N-ethyl-2-pyrrolidone, tetrahydrofuran, dioxane, N-formylmorpholine, dimethylformamide, or dimethyl sulfoxide.

A particular effect of selecting the specific solvents (Z.2) with only limited solubility in water is that when the composition (Z) is dispersed in aqueous phase, in step (II) of the process, a homogeneous solution cannot be directly formed. It is assumed that the dispersion that is present instead makes it possible for the crosslinking reactions that occur as part of step (II) (addition reactions of free primary amino groups and isocyanate groups to form urea bonds) to take place in a restricted volume, thereby ultimately allowing the formation of the microparticles defined as above.

As well as having the water solubility described, preferred solvents (Z.2) possess a boiling point of not more than 120° C., more preferably of not more than 90° C. (under atmospheric pressure, in other words 1.013 bar). This has advantages in the context of step (III) of the process, said step being described later on below, in other words the at least partial removal of the at least one organic solvent (Z.2) from the dispersion prepared in step (II) of the process. The reason is evidently that, when using the solvents (Z.2) that are preferred in this context, these solvents can be removed by distillation, for example, without the removal simultaneously of significant quantities of the water introduced in step (II) of the process. There is therefore no need, for example, for the laborious re-addition of water in order to retain the aqueous nature of the dispersion (PD).

The fraction of the at least one organic solvent (Z.2) is from 35 to 85 wt %, preferably from 40 to 75 wt %, more preferably from 45 to 70 wt %, especially preferably from 47.5 to 65 wt %, and, in one very particular embodiment, from 50 to 60 wt %, based in each case on the total amount of the composition (Z).

In the context of the present invention it has emerged that through the specific combination of a fraction as specified above for the intermediate (Z.1) in the composition (Z), and through the selection of the specific solvents (Z.2) it is possible, after the below-described steps (II) and (III), to provide polyurethane-polyurea dispersions which comprise polyurethane-polyurea particles having the requisite particle size, which further have the requisite gel fraction.

The components (Z.1) and (Z.2) described preferably make up in total at least 90 wt % of the composition (Z). Preferably the two components make up at least 95 wt %, more particularly at least 97.5 wt %, of the composition (Z). With very particular preference, the composition (Z) consists of these two components. In this context it should be noted that where neutralizing agents as described above are used, these neutralizing agents are ascribed to the intermediate when calculating the amount of an intermediate (Z.1). The reason is that in this case the intermediate (Z.1) at any rate possesses anionic groups, which originate from the use of the neutralizing agent. Accordingly, the cation that is present after these anionic groups have formed is likewise ascribed to the intermediate.

Where the composition (Z) includes other components, in addition to components (Z.1) and (Z.2), these other components are preferably just organic solvents. The solids content of the composition (Z) therefore corresponds preferably to the fraction of the intermediate (Z.1) in the composition (Z). The composition (Z) therefore possesses preferably a solids content of 15 to 65 wt %, preferably of 25 to 60 wt %, more preferably of 30 to 55 wt %, especially preferably of 35 to 52.5 wt %, and, in one especially preferred embodiment, of 40 to 50 wt %.

A particularly preferred composition (Z) therefore contains in total at least 90 wt % of components (Z.1) and (Z.2), and other than the intermediate (Z.1) includes exclusively organic solvents.

An advantage of the composition (Z) is that it can be prepared without the use of eco-unfriendly and health-injurious organic solvents such as N-methyl-2-pyrrolidone, dimethylformamide, dioxane, tetrahydro-furan, and N-ethyl-2-pyrrolidone. Preferably, accordingly, the composition (Z) contains less than 10 wt %, preferably less than 5 wt %, more preferably less than 2.5 wt % of organic solvents selected from the group consisting of N-methyl-2-pyrrolidone, dimethylformamide, dioxane, tetrahydrofuran, and N-ethyl-2-pyrrolidone. The composition (Z) is preferably entirely free from these organic solvents.

In a second step (II) of the process described here, the composition (Z) is dispersed in aqueous phase.

It is known, and also follows from what has already been said above, that in step (II), therefore, there is a deblocking of the blocked primary amino groups of the intermediate (Z.1). Indeed, as a result of the transfer of a blocked amine to the aqueous phase, the reversibly attached blocking agent is released, with consumption of water, and free primary amino groups are formed.

It is likewise clear, therefore, that the resulting free primary amino groups are then reacted with isocyanate groups likewise present in the intermediate (Z.1), or in the deblocked intermediate formed from the intermediate (Z.1), by addition reaction, with formation of urea bonds.

It is also known that the transfer to the aqueous phase means that it is possible in principle for isocyanate groups in the intermediate (Z.1), or in the deblocked intermediate formed from the intermediate (Z.1), to react with the water, with elimination of carbon dioxide, to form free primary amino groups, which can then be reacted in turn with isocyanate groups still present.

Of course, the reactions and conversions referred to above proceed in parallel with one another. Ultimately, as a result, for example, of intermolecular and intramolecular reaction or crosslinking, a dispersion is formed which comprises polyurethane-polyurea particles with defined average particle size and with defined degree of crosslinking or gel fraction.

In step (II) of the process described here, the composition (Z) is dispersed in water, there being a deblocking of the blocked primary amino groups of the intermediate (Z.1) and a reaction of the resulting free primary amino groups with the isocyanate groups of the intermediate (Z.1) and also with the isocyanate groups of the deblocked intermediate formed from the intermediate (Z.1), by addition reaction.

Step (II) of the process described here, in other words the dispersing in aqueous phase, may take place in any desired way. This means that ultimately the only important thing is that the composition (Z) is mixed with water or with an aqueous phase. With preference, the composition (Z), which after the preparation may be for example at room temperature, in other words 20 to 25° C., or at a temperature increased relative to room temperature, of 30 to 60° C., for example, can be stirred into water, producing a dispersion. The water already introduced has room temperature, for example. Dispersion may take place in pure water (deionized water), meaning that the aqueous phase consists solely of water, this being preferred. Besides water, of course, the aqueous phase may also include, proportionally, typical auxiliaries such as typical emulsifiers and protective colloids. A compilation of suitable emulsifiers and protective colloids is found in, for example, Houben Weyl, Methoden der organischen Chemie [Methods of Organic Chemistry], volume XIV/1 Makromolekulare Stoffe [Macromolecular compounds], Georg Thieme Verlag, Stuttgart 1961, p. 411 ff.

It is of advantage if in stage (II) of the process, in other words at the dispersing of the composition (Z) in aqueous phase, the weight ratio of organic solvents and water is selected such that the resulting dispersion has a weight ratio of water to organic solvents of greater than 1, preferably of 1.05 to 2/1, especially preferably of 1.1 to 1.5/1.

In step (III) of the process described here, the at least one organic solvent (Z.2) is removed at least partly from the dispersion obtained in step (II). Of course, step (III) of the process may also entail removal of other solvents as well, possibly present, for example, in the composition (Z).

The removal of the at least one organic solvent (Z.2) and of any further organic solvents may be accomplished in any way which is known, as for example by vacuum distillation at temperatures slightly raised relative to room temperature, of 30 to 60° C., for example.

The resulting polyurethane-polyurea dispersion (PD) is aqueous (regarding the basic definition of “aqueous”, see earlier on above).

A particular advantage of the dispersion (PD) for use in accordance with the invention is that it can be formulated with only very small fractions of organic solvents, yet enables the advantages described at the outset in accordance with the invention. The dispersion (PD) for use in accordance with the invention contains preferably not more than 15.0 wt %, especially preferably not more than 10 wt %, very preferably not more than 5 wt % and more preferably not more than 2.5 wt % of organic solvents (for measurement method, see Examples section).

The fraction of the polyurethane-polyurea polymer in the dispersion (PD) is preferably 25 to 55 wt %, preferably 30 to 50 wt %, more preferably 35 to 45 wt %, based in each case on the total amount of the dispersion (determined as for the determination described above for the intermediate (Z.1) via the solids content).

The fraction of water in the dispersion (PD) is preferably 45 to 75 wt %, preferably 50 to 70 wt %, more preferably 55 to 65 wt %, based in each case on the total amount of the dispersion.

It is a particular advantage of the dispersion (PD) for inventive use that it can be formulated in such a way that it consists to an extent of at least 85 wt %, preferably at least 90.0 wt %, very preferably at least 95 wt %, and even more preferably at least 97.5 wt % of the polyurethane-polyurea particles and water (the associated value is obtained by summating the amount of the particles (that is, of the polymer, determined via the solids content) and the amount of water). It has emerged that in spite of this low fraction of further components such as organic solvents in particular, the dispersions are in any case very stable, more particularly storage-stable. In this way, two relevant advantages are united. First, dispersions are provided which can be used in aqueous basecoat materials, where they lead to the performance advantages described at the outset and also in the examples hereinafter. Secondly, however, a commensurate freedom in formulation is achieved for the preparation of aqueous basecoat materials. This means that additional fractions of organic solvents can be used in the basecoat materials, being necessary, for example, in order to provide appropriate formulation of different components. But at the same time the fundamentally aqueous nature of the basecoat material is not jeopardized. On the contrary: the basecoat materials can nevertheless be formulated with comparatively low fractions of organic solvents, and therefore have a particularly good environmental profile.

Even more preferred is for the dispersion, other than the polymer, to include only water and any organic solvents, in the form, for example, of residual fractions, not fully removed in stage (III) of the process. The solids content of the dispersion (PD) is therefore preferably 25% to 55%, preferably 30% to 50%, more preferably 35% to 45%, and more preferably still is in agreement with the fraction of the polymer in the dispersion.

An advantage of the dispersion (PD) is that it can be prepared without the use of eco-unfriendly and health-injurious organic solvents such as N-methyl-2-pyrrolidone, dimethylformamide, dioxane, tetrahydro-furan, and N-ethyl-2-pyrrolidone. Accordingly the dispersion (PD) contains preferably less than 7.5 wt %, preferably less than 5 wt %, more preferably less than 2.5 wt % of organic solvents selected from the group consisting of N-methyl-2-pyrrolidone, dimethylformamide, dioxane, tetrahydrofuran, and N-ethyl-2-pyrrolidone. The dispersion (PD) is preferably entirely free from these organic solvents.

The polyurethane-polyurea polymer present in the dispersion preferably possesses hardly any hydroxyl groups, or none. The OH number of the polymer, based on the solids content, is preferably less than 15 mg KOH/g, more particularly less than 10 mg KOH/g, more preferably still less than 5 mg KOH/g (for measurement method, see Examples section).

The fraction of the one or more dispersions (PD), based on the total weight of the aqueous basecoat material (b.2.1), is preferably 5 to 60 wt %, more preferably 15 to 50 wt %, and very preferably 20 to 45 wt %.

The fraction of the polyurethane-polyurea polymers originating from the dispersions (PD), based on the total weight of the aqueous basecoat material (b.2.1), is preferably from 2.0 to 24.0 wt %, more preferably 6.0 to 20.0 wt % and very preferably 8.0 to 18.0 wt %.

Determining or specifying the fraction of the polyurethane-polyurea polymers originating from the dispersions of the invention in the basecoat material may be done via the determination of the solids content of a dispersion (PD) of the invention which is to be used in the basecoat material.

In the case of a possible particularization to basecoat materials comprising preferred dispersions (PD) in a specific proportional range, the following applies. The dispersions (PD) which do not fall within the preferred group may of course still be present in the basecoat material. In that case the specific proportional range applies only to the preferred group of dispersions (PD). It is preferred nonetheless for the total proportion of dispersions (PD), consisting of dispersions from the preferred group and dispersions which are not part of the preferred group, to be subject likewise to the specific proportional range.

In the case of a restriction to a proportional range of 15 to 50 wt % and to a preferred group of dispersions (PD), therefore, this proportional range evidently applies initially only to the preferred group of dispersions (PD). In that case, however, it would be preferable for there to be likewise from 15 to 50 wt % in total present of all originally encompassed dispersions, consisting of dispersions from the preferred group and dispersions which do not form part of the preferred group. If, therefore, 35 wt % of dispersions (PD) of the preferred group are used, not more than 15 wt % of the dispersions of the non-preferred group may be used.

The stated principle is valid, for the purposes of the present invention, for all stated components of the basecoat material and for their proportional ranges—for example, for the pigments specified later on below, or else for the crosslinking agents specified later on below, such as melamine resins.

The basecoat material (b.2.1) for use in accordance with the invention preferably comprises at least one pigment. Reference here is to conventional pigments imparting color and/or optical effect.

Such color pigments and effect pigments are known to those skilled in the art and are described, for example, in Rompp-Lexikon Lacke and Druckfarben, Georg Thieme Verlag, Stuttgart, New York, 1998, pages 176 and 451. The terms “coloring pigment” and “color pigment” are interchangeable, just like the terms “optical effect pigment” and “effect pigment”.

Preferred effect pigments are, for example, platelet-shaped metal effect pigments such as lamellar aluminum pigments, gold bronzes, oxidized bronzes and/or iron oxide-aluminum pigments, pearlescent pigments such as pearl essence, basic lead carbonate, bismuth oxide chloride and/or metal oxide-mica pigments and/or other effect pigments such as lamellar graphite, lamellar iron oxide, multilayer effect pigments composed of PVD films and/or liquid crystal polymer pigments. Particularly preferred are lamellar metal effect pigments, more particularly lamellar aluminum pigments. Typical color pigments especially include inorganic coloring pigments such as white pigments such as titanium dioxide, zinc white, zinc sulfide or lithopone; black pigments such as carbon black, iron manganese black, or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chromium orange; or yellow iron oxide, nickel titanium yellow, chromium titanium yellow, cadmium sulfide, cadmium zinc sulfide, chromium yellow or bismuth vanadate.

The fraction of the pigments is preferably situated in the range from 1.0 to 40.0 wt %, preferably 2.0 to 35.0 wt %, more preferably 5.0 to 30.0 wt %, based on the total weight of the aqueous basecoat material (b.2.1) in each case.

The aqueous basecoat material (b.2.1) preferably further comprises at least one polymer as binder that is different from the polyurethane-polyurea polymers present in the dispersions (PD), more particularly at least one polymer selected from the group consisting of polyurethanes, polyesters, polyacrylates and/or copolymers of the stated polymers, more particularly polyesters and/or polyurethane polyacrylates. Preferred polyesters are described, for example, in DE 4009858 A1 in column 6, line 53 to column 7, line 61 and column 10, line 24 to column 13, line b 3, or WO 2014/033135 A2, page 2, line 24 to page 7, line 10 and page 28, line 13 to page 29, line 13. Preferred polyurethane-polyacrylate copolymers (acrylated polyurethanes) and their preparation are described in, for example, WO 91/15528 A1, page 3, line 21 to page 20, line 33, and DE 4437535 A1, page 2, line 27 to page 6, line 22. The described polymers as binders are preferably hydroxy-functional and especially preferably possess an OH number in the range from 15 to 200 mg KOH/g, more preferably from 20 to 150 mg KOH/g. The basecoat materials more preferably comprise at least one hydroxy-functional polyurethane-polyacrylate copolymer, more preferably still at least one hydroxy-functional polyurethane-polyacrylate copolymer and also at least one hydroxy-functional polyester.

The proportion of the further polymers as binders may vary widely and is situated preferably in the range from 1.0 to 25.0 wt %, more preferably 3.0 to 20.0 wt %, very preferably 5.0 to 15.0 wt %, based in each case on the total weight of the basecoat material (b.2.1)

The basecoat material (b.2.1) may further comprise at least one typical crosslinking agent known per se. If it comprises a crosslinking agent, said agent comprises preferably at least one aminoplast resin and/or at least one blocked polyisocyanate, preferably an aminoplast resin. Among the aminoplast resins, melamine resins in particular are preferred.

If the basecoat material (b.2.1) does comprise crosslinking agents, the proportion of these crosslinking agents, more particularly aminoplast resins and/or blocked polyisocyanates, very preferably aminoplast resins and, of these, preferably melamine resins, is preferably in the range from 0.5 to 20.0 wt %, more preferably 1.0 to 15.0 wt %, very preferably 1.5 to 10.0 wt %, based in each case on the total weight of the basecoat material (b.2.1).

The basecoat material (b.2.1) may further comprise at least one thickener. Suitable thickeners are inorganic thickeners from the group of the phyllosilicates such as lithium aluminum magnesium silicates. It is nevertheless known that coating materials whose profile of rheological properties is determined via the primary or predominant use of such inorganic thickeners are in need of improvement in terms of their solids content, in other words can be formulated only with decidedly low solids contents of less than 20%, for example, without detriment to important performance properties. A particular advantage of the basecoat material (b.2.1) is that it can be formulated without, or without a great fraction of, such inorganic phyllosilicates employed as thickeners. Accordingly, the fraction of inorganic phyllosilicates used as thickeners, based on the total weight of the basecoat material, is preferably less than 0.7 wt %, especially preferably less than 0.3 wt %, and more preferably still less than 0.1 wt %. With very particular preference, the basecoat material is entirely free of such inorganic phyllosilicates used as thickeners.

Instead, the basecoat material may preferably comprise at least one organic thickener, as for example a (meth)acrylic acid-(meth)acrylate copolymer thickener or a polyurethane thickener. Employed with preference are associative thickeners, such as the associative polyurethane thickeners known per se, for example. Associative thickeners, as is known, are termed water-soluble polymers which have strongly hydrophobic groups at the chain ends or in side chains, and/or whose hydrophilic chains contain hydrophobic blocks or concentrations in their interior. As a result, these polymers possess a surfactant character and are capable of forming micelles in aqueous phase. In similarity with the surfactants, the hydrophilic regions remain in the aqueous phase, while the hydrophobic regions enter into the particles of polymer dispersions, adsorb on the surface of other solid particles such as pigments and/or fillers, and/or form micelles in the aqueous phase. Ultimately a thickening effect is achieved, without any increase in sedimentation behavior. Thickeners of this kind are available commercially, as for example under the trade name Adekanol (from Adeka Corporation).

The proportion of the organic thickeners is preferably in the range from 0 to 5.0 wt %, more preferably 0 to 3.0 wt %, very preferably 0 to 2.0 wt %, based in each case on the total weight of the basecoat material.

A very particular advantage of the basecoat materials (b.2.1) used in accordance with the invention is that they can be formulated without the use of any thickeners, and yet can have outstanding properties in terms of their rheological profile. In this way, in turn, a lower complexity is achieved for the coating material, or an increase in the formulation freedom for the basecoat material.

Furthermore, the basecoat material (b.2.1) may further comprise at least one further adjuvant. Examples of such adjuvants are salts which are thermally decomposable without residue or substantially without residue, polymers as binders that are curable physically, thermally and/or with actinic radiation and that are different from the polymers already stated as binders, further crosslinking agents, organic solvents, reactive diluents, transparent pigments, fillers, molecularly dispersively soluble dyes, nanoparticles, light stabilizers, antioxidants, deaerating agents, emulsifiers, slip additives, polymerization inhibitors, initiators of radical polymerizations, adhesion promoters, flow control agents, film-forming assistants, sag control agents (SCAs), flame retardants, corrosion inhibitors, waxes, siccatives, biocides, and matting agents. Such adjuvants are used in the customary and known amounts.

The solids content of the basecoat material (b.2.1) may vary according to the requirements of the case in hand. The solids content is guided primarily by the viscosity that is needed for application, more particularly spray application. A particular advantage is that the basecoat material of the invention, for comparatively high solids contents, is able nevertheless to have a viscosity which allows appropriate application.

The solids content of the basecoat material if it comprises at least one crosslinking agent is preferably at least 25%, more preferably at least 27.5%, especially preferably at least 30%.

If the basecoat material does not contain any crosslinking agent, the solids content is preferably at least 15%, more preferably at least 18%, more preferably still at least 21%.

Under the stated conditions, in other words at the stated solids contents, preferred basecoat materials (b.2.1) have a viscosity of 40 to 150 mPa·s, more particularly 70 to 110 mPa·s, at 23° C. under a shearing load of 1000 l/s (for further details regarding the measurement method, see Examples section). For the purposes of the present invention, a viscosity within this range under the stated shearing load is referred to as spray viscosity (working viscosity). As is known, coating materials are applied at spray viscosity, meaning that under the conditions then present (high shearing load) they possess a viscosity which in particular is not too high, so as to permit effective application. This means that the setting of the spray viscosity is important, in order to allow a paint to be applied at all by spray methods, and to ensure that a complete, uniform coating film is able to form on the substrate to be coated. A particular advantage is that even a basecoat material (b.2.1) adjusted to spray viscosity possesses a high solids content. The preferred ranges of the solids content, particularly the lower limits, therefore suggest that in the applicable state, preferably, the basecoat material (b.2.1) has comparatively high solids contents.

The basecoat material of the invention is aqueous (regarding the definition of “aqueous”, see above).

The fraction of water in the basecoat material (b.2.1) is preferably from 35 to 70 wt %, and more preferably 42 to 63 wt %, based in each case on the total weight of the basecoat material.

Even more preferred is for the percentage sum of the solids content of the basecoat material and the fraction of water in the basecoat material to be at least 70 wt %, preferably at least 75 wt %. Among these figures, preference is given to ranges of 75 to 95 wt %, in particular 80 to 90 wt %. In this reporting, the solids content, which traditionally only possesses the unit “%”, is reported in “wt %”. Since the solids content ultimately also represents a percentage weight figure, this form of representation is justified. If, then, a basecoat material has a solids content of 35% and a water content of 50 wt %, for example, the percentage sum defined above, from the solids content of the basecoat material and the fraction of water in the basecoat material, is 85 wt %.

This means in particular that preferred basecoat materials comprise components that are in principle a burden on the environment, such as organic solvents in particular, in relation to the solids content of the basecoat material, at only low fractions. The ratio of the volatile organic fraction of the basecoat material (in wt %) to the solids content of the basecoat material (in analogy to the representation above, here in wt %) is preferably from 0.05 to 0.7, more preferably from 0.15 to 0.6. In the context of the present invention, the volatile organic fraction is considered to be that fraction of the basecoat material that is considered neither part of the water fraction nor part of the solids content.

Another advantage of the basecoat material (b.2.1) is that it can be prepared without the use of eco-unfriendly and health-injurious organic solvents such as N-methyl-2-pyrrolidone, dimethylformamide, dioxane, tetrahydrofuran, and N-ethyl-2-pyrrolidone. Accordingly, the basecoat material preferably contains less than 10 wt %, more preferably less than 5 wt %, more preferably still less than 2.5 wt % of organic solvents selected from the group consisting of N-methyl-2-pyrrolidone, dimethylformamide, dioxane, tetrahydrofuran, and N-ethyl-2-pyrrolidone. The basecoat material is preferably entirely free from these organic solvents.

The basecoat materials can be produced using the mixing assemblies and mixing techniques that are customary and known for the production of basecoat materials.

For the basecoat materials (b.2.2.x) used in the process of the invention it is the case that at least one of these basecoat materials has the inventively essential features described for the basecoat material (b.2.1). This means, in particular, that at least one of the basecoat materials (b.2.2.x) comprises at least one aqueous polyurethane-polyurea dispersion (PD). The preferred features and embodiments described as part of the description of the basecoat material (b.2.1) preferably also apply to at least one of basecoat materials (b.2.2.x).

In the preferred variants of stage (2.2) of the process of the invention, described earlier on above, a first basecoat material (b.2.2.a) is first of all applied, and may also be termed a color-preparatory basecoat material. It therefore serves as a base for a color and/or effect basecoat film that then follows, this being a film which is then able optimally to fulfill its function of imparting color and/or effect.

In one particular embodiment, a color-preparatory basecoat material is substantially free from chromatic pigments and effect pigments. More particularly preferably a basecoat material of this kind contains less than 2 wt %, preferably less than 1 wt %, of chromatic pigments and effect pigments, based in each case on the total weight of the aqueous basecoat material. In this embodiment the color-preparatory basecoat material preferably comprises black and/or white pigments, especially preferably both kinds of these pigments. It comprises preferably 5 to 30 wt %, preferably 10 to 25 wt %, of white pigments, and 0.01 to 1.00 wt %, preferably 0.1 to 0.5 wt %, of black pigments, based in each case on the total weight of the basecoat material. The resultant white, black, and more particularly gray color, which can be adjusted in different lightness stages through the ratio of white pigments and black pigments, represents an individually adaptable basis for the basecoat film system that then follows, allowing the color and/or the effect imparted by the subsequent basecoat system to be manifested optimally. The pigments are known to the skilled person and have also been described earlier on above. A preferred white pigment here is titanium dioxide, a preferred black pigment carbon black. As already described, however, this basecoat material may of course also comprise chromatic and/or effect pigments. This variant is appropriate especially when the resultant multicoat paint system is to have a highly chromatic hue, as for example a very deep red or yellow. Where pigments in appropriately chromatic hue are also added to the color-preparatory basecoat material, a further improved coloration can be achieved.

The color and/or effect basecoat material(s) for the second basecoat film or for the second and third basecoat films within this embodiment are adapted in accordance with the ultimately desired coloration of the overall system. Where the desire is for a white, black, or gray color, the at least one further basecoat material comprises the corresponding pigments and in terms of the pigment composition ultimately resembles the color-preparatory basecoat material. Where the desire is for a chromatic and/or effect paint system, as for example a chromatic solid-color paint system or a metallic-effect paint system, corresponding chromatic and/or effect pigments are used in amounts of, for example, 1 to 15 wt %, preferably 3 to 10 wt %, based in each case on the total weight of the basecoat material. Basecoat materials of this kind may of course also include black and/or white pigments as well for the purpose of lightness adaptation.

The process of the invention allows multicoat paint systems to be produced on metallic substrates without a separate curing step. Nevertheless, application of the process of the invention results in multicoat paint systems which exhibit excellent stability toward pinholes, meaning that even relatively high film thicknesses of the corresponding basecoat films can be built up without loss of esthetic quality. Properties such as the adhesion or the overall appearance are also outstanding.

The present invention also relates to an aqueous mixing varnish system for the production of aqueous basecoat materials. The mixing varnish system, based in each case on the total weight of the aqueous mixing varnish system, comprises

10 to 25 wt % of at least one polyurethane-polyurea polymer which originates from at least one dispersion (PD),

0 to 15 wt % of a crosslinking agent selected from the group of the aminoplast resins and blocked polyisocyanates,

3 to 15 wt % of at least one polyester having an OH number in the range from 15 to 200 mg KOH/g,

2 to 10 wt % of at least one polyurethane-polyacrylate copolymer having an OH number in the range from 15 to 200 mg KOH/g,

45 to 55 wt % of water, and

5 to 15 wt % of at least one organic solvent,

the components described making up in total at least 90 wt %, preferably at least 95 wt %, of the mixing varnish system.

The mixing varnish system is preferably substantially free from pigments, hence containing less than 1 wt % of pigments. With particular preference it is entirely free of pigments.

It has emerged that the mixing varnish system is outstandingly suitable for use for the production of aqueous basecoat materials, by individually adapted additization with, in particular, pigments and optionally various additives. One and the same mixing varnish system can therefore be used in order to produce different aqueous basecoat materials by subsequent and individual additization. This of course makes for a massive easing of the work burden, and hence an increase in economy, in the formulation of basecoat materials, particularly on the industrial scale. The mixing varnish system can be separately produced and stored and then additized with corresponding pigment pastes, for example, when called for.

The present invention, accordingly, also relates to a process for producing aqueous basecoat materials, comprising the addition of pigments, particularly in the form of pigment pastes, to a mixing varnish system as described above.

### EXAMPLES

Methods of Determination

1. Solids Content

Unless otherwise indicated, the solids content, also referred to as solid fraction hereinafter, was determined in accordance with DIN EN ISO 3251 at 130° C.; 60 min, initial mass 1.0 g. If reference is made in the context of the present invention to an official standard, this of course means the version of the standard that was current on the filing date, or, if no current version exists at that date, then the last current version.

2. Isocyanate Content

The isocyanate content, also referred to below as NCO content, was determined by adding an excess of a 2% strength N,N-dibutylamine solution in xylene to a homogeneous solution of the samples in acetone/N-ethylpyrrolidone (1:1 vol %), by potentiometric back-titration of the amine excess with 0.1 N hydrochloric acid, in a method based on DIN EN ISO 3251, DIN EN ISO 11909, and DIN EN ISO 14896. The NCO content of the polymer, based on solids, can be calculated back via the fraction of a polymer (solids content) in solution.

3. Hydroxyl Number

The hydroxyl number was determined on the basis of R.-P. Krüger, R. Gnauck and R. Algeier, Plaste and Kautschuk, 20, 274 (1982), by means of acetic anhydride in the presence of 4-dimethylaminopyridine as a catalyst in a tetrahydrofuran (THF)/dimethylformamide (DMF) solution at room temperature, by fully hydrolyzing the excess of acetic anhydride remaining after acetylation and conducting a potentiometric back-titration of the acetic acid with alcoholic potassium hydroxide solution. Acetylation times of 60 minutes were sufficient in all cases to guarantee complete conversion.

4. Acid Number

The acid number was determined on the basis of DIN EN ISO 2114 in homogeneous solution of tetrahydrofuran (THF)/water (9 parts by volume of THF and 1 part by volume of distilled water) with ethanolic potassium hydroxide solution.

5. Degree of Neutralization

The degree of neutralization of a component x was calculated from the amount of substance of the carboxylic acid groups present in the component (determined via the acid number) and the amount of substance of the neutralizing agent used.

6. Amine Equivalent Mass

The amine equivalent mass (solution) serves for determining the amine content of a solution, and was ascertained as follows. The sample for analysis was dissolved at room temperature in glacial acetic acid and titrated against 0.1N perchloric acid in glacial acetic acid in the presence of crystal violet. The initial mass of the sample and the consumption of perchloric acid gave the amine equivalent mass (solution), the mass of the solution of the basic amine that is needed to neutralize one mole of perchloric acid.

7. Degree of Blocking of the Primary Amino Groups

The degree of blocking of the primary amino groups was determined by means of IR spectrometry using a Nexus FT IR spectrometer (from Nicolet) with the aid of an IR cell (d=25 m, KBr window) at the absorption maximum at 3310 cm⁻¹ on the basis of concentration series of the amines used and standardization to the absorption maximum at 1166 cm⁻¹ (internal standard) at 25° C.

8. Solvent Content

The amount of an organic solvent in a mixture, as for example in an aqueous dispersion, was determined by means of gas chromatography (Agilent 7890A, 50 m silica capillary column with polyethylene glycol phase or 50 m silica capillary column with polydimethylsiloxane phase, helium carrier gas, 250° C. split injector, 40-220° C. oven temperature, flame ionization detector, 275° C. detector temperature, n-propyl glycol as internal standard).

9. Number-Average Molar Mass

The number-average molar mass (Mₙ) was determined, unless otherwise indicated, by means of a vapor pressure osmometer 10.00 (from Knauer) on concentration series in toluene at 50° C. with benzophenone as calibration substance for the determination of the experimental calibration constant of the measuring instrument used, by the method of E. Schroder, G. Muller, K.-F. Arndt, “Leitfaden der Polymer-charakterisierung” [Principles of polymer characterization], Akademie-Verlag, Berlin, pp. 47-54, 1982.

10. Average Particle Size

The average particle sizes (volume average) of the polyurethane-polyurea particles present in the dispersions (PD) of the invention were determined in the context of the present invention by means of photon correlation spectroscopy (PCS).

Employed specifically for the measurement was a Malvern Nano S90 (from Malvern Instruments) at 25±1° C. The instrument covers a size range from 3 to 3000 nm and was equipped with a 4 mW He—Ne laser at 633 nm. The dispersions (PD) were diluted with particle-free, deionized water as dispersing medium, before being subjected to measurement in a 1 ml polystyrene cell at suitable scattering intensity. Evaluation took place using a digital correlator, with the assistance of the Zetasizer analysis software, version 6.32 (from Malvern Instruments). Measurement took place five times, and the measurements were repeated on a second, freshly prepared sample. The standard deviation of a 5-fold determination was 4%. The maximum deviation of the arithmetic mean of the volume average (V-average mean) of five individual measurements was ±15%. The reported average particle size (volume average) is the arithmetic mean of the average particle size (volume average) of the individual preparations. Verification was carried out using polystyrene standards having certified particle sizes between 50 to 3000 nm.

11. Gel Fraction

The gel fraction of the polyurethane-polyurea particles (microgel particles) present in the dispersions (PD) of the invention is determined gravimetrically in the context of the present invention. Here, first of all, the polymer present was isolated from a sample of an aqueous dispersion (PD) (initial mass 1.0 g) by freeze-drying. Following determination of the solidification temperature—the temperature above which the electrical resistance of the sample shows no further change when the temperature is lowered further—the fully frozen sample underwent its main drying, customarily in the drying vacuum pressure range between 5 mbar and 0.05 mbar, at a drying temperature lower by 10° C. than the solidification temperature. By graduated increase in the temperature of the heated surfaces beneath the polymer to 25° C., rapid freeze-drying of the polymers was achieved; after a drying time of typically 12 hours, the amount of isolated polymer (solid fraction, determined by the freeze-drying) was constant and no longer underwent any change even on prolonged freeze-drying. Subsequent drying at a temperature of the surface beneath the polymer of 30° C. with the ambient pressure reduced to maximum (typically between 0.05 and 0.03 mbar) produced optimum drying of the polymer.

The isolated polymer was subsequently sintered in a forced air oven at 130° C. for one minute and thereafter extracted for 24 hours at 25° C. in an excess of tetrahydrofuran (ratio of tetrahydrofuran to solid fraction=300:1). The insoluble fraction of the isolated polymer (gel fraction) was then separated off on a suitable frit, dried in a forced air oven at 50° C. for 4 hours, and subsequently reweighed.

It was further ascertained that at the sintering temperature of 130° C., with variation in the sintering times between one minute and twenty minutes, the gel fraction found for the microgel particles is independent of sintering time. It can therefore be ruled out that crosslinking reactions subsequent to the isolation of the polymeric solid increase the gel fraction further.

The gel fraction determined in this way in accordance with the invention is also called gel fraction (freeze-dried).

In parallel, a gel fraction, hereinafter also called gel fraction (130° C.), was determined gravimetrically, by isolating a polymer sample from aqueous dispersion (initial mass 1.0 g) at 130° C. for 60 minutes (solids content). The mass of the polymer was ascertained, after which the polymer was extracted in an excess of tetrahydrofuran at 25° C., in analogy to the procedure described above, for 24 hours, after which the insoluble fraction (gel fraction) was separated off, dried, and reweighed.

12. Solubility in Water

The solubility of an organic solvent in water was determined at 20° C. as follows. The respective organic solvent and water were combined in a suitable glass vessel, mixed, and the mixture was subsequently equilibrated. The amounts of water and of the solvent were selected such that two phases separate from one another were obtained after the equilibration. After the equilibration, a sample is taken from the aqueous phase (that is, the phase containing more water than organic solvent) using a syringe, and this sample was diluted with tetrahydrofuran in a 1/10 ratio, the fraction of the solvent being determined by means of gas chromatography (for conditions see section 8. Solvent content).

If two phases do not form irrespective of the amounts of water and the solvent, the solvent is miscible with water in any weight ratio. This solvent that is therefore infinitely soluble in water (acetone, for example) is therefore at any rate not a solvent (Z.2).

13. Solids Content (Calculated):

The volume solids content was calculated by the method of VdL-RL 08, “Ermittlung des Festkörpervolumens von Korrosionsschutz-Beschichtungsstoffen als Basis für Ergiebigkeitsberechnungen” [Determining the volume of solids of anticorrosion coating materials as a basis for productivity calculations], Verband der Lackindustrie e.V., issued Dec. 1999. The volume solids content VSC (volume of solids) was calculated according to the following formula, incorporating the physical properties of the relevant ingredients (density of the solvents, density of the solids):

VSC=(density (wet paint)×solids fraction (wet paint))/density (baked paint)
VSC volume solids content in %
Density (wet paint): calculated density of the wet paint, from the density of the individual components (density of solvents and density of solids) in g/cm³
Solids fraction (wet paint) solids content (in %) of the wet paint, determined according to DIN EN ISO 3251 at 130° C., 60 min, initial mass 1.0 g
Density (baked paint) density of the baked paint on the metal panel in g/cm³

Preparation of a Dispersion (PD)

A dispersion (PD) was prepared as follows:

a) Preparation of a Partly Neutralized Prepolymer Solution

In a reaction vessel equipped with stirrer, internal thermometer, reflux condenser, and electrical heating, 559.7 parts by weight of a linear polyester polyol and 27.2 parts by weight of dimethylolpropionic acid (from GEO Speciality Chemicals) were dissolved under nitrogen in 344.5 parts by weight of methyl ethyl ketone. The linear polyester diol was prepared beforehand from dimerized fatty acid (Pripol® 1012, from Croda), isophthalic acid (from BP Chemicals), and hexane-1,6-diol (from BASF SE) (weight ratio of the starting materials: dimeric fatty acid to isophthalic acid to hexane-1,6-diol=54.00:30.02:15.98), and had a hydroxyl number of 73 mg KOH/g solid fraction, an acid number of 3.5 mg KOH/g solid fraction, a calculated number-average molar mass of 1379 g/mol, and a number-average molar mass as determined via vapor pressure osmometry of 1350 g/mol.

Added in succession to the resulting solution at 30° C. were 213.2 parts by weight of dicyclohexylmethane 4,4′-diisocyanate (Desmodur® W, from Bayer MaterialScience) with an isocyanate content of 32.0 wt %, and 3.8 parts by weight of dibutyltin dilaurate (from Merck). The mixture was then heated to 80° C. with stirring. Stirring was continued at this temperature until the isocyanate content of the solution was constant at 1.49% by weight. Thereafter 626.2 parts by weight of methyl ethyl ketone were added to the prepolymer, and the reaction mixture was cooled to 40° C. When 40° C. had been reached, 11.8 parts by weight of triethylamine (from BASF SE) were added dropwise over the course of two minutes, and the mixture was stirred for a further 5 minutes.

b) Reaction of the Prepolymer with Diethylenetriaminediketimine

Then 30.2 parts by weight of a 71.9 wt % dilution of diethylenetriaminediketimine in methyl isobutyl ketone were mixed in over the course of one minute (ratio of prepolymer isocyanate groups to diethylenetriaminediketimine (having a secondary amino group): 5:1 mol/mol, corresponding to two NCO groups per blocked primary amino group), and the reaction temperature rose by 1° C. briefly following addition to the prepolymer solution. The dilution of diethylenetriaminediketimine in methyl isobutyl ketone was prepared beforehand by azeotropic removal of water of reaction in the reaction of diethylenetriamine (from BASF SE) with methyl isobutyl ketone in methyl isobutyl ketone at 110-140° C. Adjustment to an amine equivalent mass (solution) of 124.0 g/eq was carried out by dilution with methyl isobutyl ketone. Blocking of the primary amino groups of 98.5% was determined by means of IR spectroscopy, on the basis of the residual absorption at 3310 cm⁻¹. The solids content of the polymer solution containing isocyanate groups was found to be 45.3%.

c) Dispersion and Vacuum Distillation

After 30 minutes of stirring at 40° C., the contents of the reactor were dispersed in 1206 parts by weight of deionized water (23° C.) over the course of 7 minutes. Methyl ethyl ketone was distilled off from the resulting dispersion under reduced pressure at 45° C., and any losses of solvent and water were made up with deionized water, giving a solids content of 40 wt %. A white, stable, solids-rich, low-viscosity dispersion with crosslinked particles was obtained, which showed no sedimentation at all even after 3 months.

The characteristics of the resulting microgel dispersion were as follows:

| Solids content (130° C., 60 min, 1 g): | 40.2 | wt % |
|---|---|---|
| Methyl ethyl ketone content (GC): | 0.2 | wt % |
| Methyl isobutyl ketone content (GC): | 0.1 | wt % |
| Viscosity (23° C., rotary viscometer, | 15 | mPa · s |
| shear rate = 1000/s): | | |
| Acid number | 17.1 | mg KOH/g |
| | Solids content | |
| Degree of neutralization (calculated) | 49% | |
| pH (23° C.) | 7.4 | |
| Particle size (photon correlation | 167 | nm |
| spectroscopy, volume average) | | |
| Gel fraction (freeze-dried) | 85.1 | wt % |
| Gel fraction (130° C.) | 87.3 | wt % |

Production of Waterborne Basecoat Materials

The components listed in table 1 were stirred together in the order stated to give aqueous mixing varnish systems. While mixing varnish system 1 includes a melamine resin as crosslinking agent, mixing varnish system 2 is entirely free from crosslinking agents. Both mixing varnish systems comprise the dispersion (PD) described above, and are entirely free from thickeners such as inorganic thickeners, for example.

TABLE 1
Mixing varnish systems 1 and 2

| | Mixing varnish | Mixing varnish |
|---|---|---|
| | system 1 | system 2 |
| Component | Parts by wt | Parts by wt |
| Dispersion (PD) | 55.000 | 54.000 |
| Butyl glycol | 5.300 | 4.500 |
| Water | 8.300 | 11.000 |
| Polyester prepared as per page 28, | 5.400 | — |
| lines 13 to 33 of | | |
| WO 2014/033135 A2 | | |
| Polyester dispersion prepared as | — | 12.500 |
| per example D, column 16, lines | | |
| 37-59 Of DE 4009858 A1 | | |
| Polyurethane-polyacrylate | 9.700 | 9.000 |
| copolymer dispersion prepared as | | |
| per page 7, line 55 to page 8, | | |
| line 23 of DE 4437535 A1 | | |
| Aqueous solution of | 1.600 | 3.300 |
| dimethylethanolamine (10% | | |
| strength) | | |
| Polypropylene glycol | 1.400 | 1.500 |
| TMDD BG 52 (BASF) (contains 48 | 3.200 | 3.000 |
| wt % of butyl glycol) | | |
| Melamine-formaldehyde resin | 10.100 | — |
| (Resimene 755) | | |

Starting from the mixing varnish systems described in table 1, different solid-color aqueous basecoat materials and color and effect aqueous basecoat materials were produced. For this purpose, the mixing varnish systems were additized with the desired tinting pastes and optionally with further additives and solvents. In this way it is possible for example, according to requirement, to use UV protection additives and/or additives for flow control or for the reduction of surface tension.

Tables 2 to 5 show the compositions of the aqueous basecoat materials produced, with the components stated having been mixed in the order stated. Also listed individually here are the constituents of the mixing varnish systems, since the use of the mixing varnish systems, though advantageous, is not absolutely necessary. The same basecoat materials result by corresponding combining of the individual components in the order stated.

All aqueous basecoat materials (BC) had a pH of 7.8 to 8.6 and a spray viscosity of 70 to 110 mPa·s under a shearing load of 1000 s⁻¹, measured with a rotational viscosimeter (Rheomat RM 180 instrument from Mettler-Toledo) at 23° C.

TABLE 2
Basecoat materials 1 (gray) and 2 (white),
based on mixing varnish system 1

| | BC 1 | BC 2 |
|---|---|---|
| | (gray) | (white) |
| Component | Parts by wt. | Parts by wt. |
| Dispersion (PD) | 35.396 | 22.963 |
| Butyl glycol | 3.411 | 2.213 |
| Water | 5.342 | 3.465 |
| Polyester prepared as per page 28, | 3.475 | 2.255 |
| lines 13 to 33 of | | |
| WO 2014/033135 A2 | | |
| Polyurethane-polyacrylate | 6.243 | 4.050 |
| copolymer dispersion prepared as | | |
| per page 7, line 55 to page 8, | | |
| line 23 of DE 4437535 A1 | | |
| Aqueous solution of | 1.030 | 0.668 |
| dimethylethanolamine (10% | | |
| strength) | | |
| Polypropylene glycol | 0.901 | 0.585 |
| TMDD BG 52 (BASF) (contains 48 wt % | 2.059 | 1.336 |
| of butyl glycol) | | |
| Melamine-formaldehyde resin | 6.500 | 4.217 |
| (Resimene 755) | | |
| Catalyst solution (AMP-PTSA- | 0.891 | — |
| solution) | | |
| Tinting paste (black) | 1.485 | — |
| Tinting paste (white) | 27.228 | 48.880 |
| Tinting paste (black) | — | 0.255 |
| TINUVIN 384-2, 95% MPA | — | 0.611 |
| TINUVIN 123 | — | 0.407 |
| Water | 5.050 | 7.230 |
| Aqueous solution of | 0.990 | 0.611 |
| dimethylethanolamine (10% | | |
| strength) | | |

Basecoat materials 1 and 2 are stable on storage at 40° C. for at least 4 weeks, meaning that within this time they show no sedimentation tendency at all and no significant change (less than 15%) in the low-shear viscosity (shearing load of 1 s⁻¹, measured with a rotational viscosimeter). Basecoat material 1 has a solids content of 42% and a calculated volume solids content of 35%. Basecoat material 2 has a solids content of 47% and a calculated volume solids content of 35%.

TABLE 3
Basecoat materials 3 (gray) and 4 (white),
based on mixing varnish system 2

| | BC 3 | BC 4 |
|---|---|---|
| | (gray) | (white) |
| Component | Parts by wt. | Parts by wt. |
| Dispersion (PD) | 38.591 | 24.923 |
| Butyl glycol | 3.216 | 2.077 |
| Water | 7.861 | 5.077 |
| Polyester dispersion prepared as | 8.933 | 5.769 |
| per example D, column 16, lines | | |
| 37-59 of DE 4009858 A1 | | |
| Polyurethane-polyacrylate | 6.432 | 4.154 |
| copolymer dispersion prepared as | | |
| per page 7, line 55 to page 8, | | |
| line 23 of DE 4437535 A1 | | |
| Aqueous solution of | 2.323 | 1.500 |
| dimethylethanolamine (10% | | |
| strength) | | |
| Polypropylene glycol | 1.072 | 0.692 |
| TMDD BG 52 (BASF) (contains 48 wt % | 2.144 | 1.385 |
| of butyl glycol) | | |
| Tinting paste (white) | 25.000 | 47.000 |
| Tinting paste (black) | 1.500 | 0.250 |
| Water | 2.000 | 7.500 |
| Aqueous solution of | 0.850 | 0.800 |
| dimethylethanolamine (10% | | |
| strength) | | |

Basecoat materials 3 and 4 are stable on storage at 40° C. for at least 4 weeks, meaning that within this time they show no sedimentation tendency at all and no significant change (less than 15%) in the low-shear viscosity (shearing load of 1 s⁻¹, measured with a rotational viscosimeter). Basecoat material 3 has a solids content of 38% and a calculated volume solids content of 32%. Basecoat material 4 has a solids content of 42% and a calculated volume solids content of 31%.

TABLE 4
Basecoat materials 5 (silver) and 6 (red),
based on mixing varnish system 1

| | BC 5 | BC 6 |
|---|---|---|
| | (silver) | (red) |
| Component | Parts by wet. | Parts by wt. |
| Dispersion (PD) | 30.733 | 30.483 |
| Butyl glycol | 2.962 | 2.937 |
| Water | 4.638 | 4.600 |
| Polyester prepared as per page 28, | 3.017 | 2.993 |
| lines 13 to 33 of | | |
| WO 2014/033135 A2 | | |
| Polyurethane-polyacrylate | 5.421 | 5.376 |
| copolymer dispersion prepared as | | |
| per page 7, line 55 to page 8, | | |
| line 23 of DE 4437535 A1 | | |
| Aqueous solution of | 0.894 | 0.887 |
| dimethylethanolamine (10% | | |
| strength) | | |
| Polypropylene glycol | 0.782 | 0.776 |
| TMDD BG 52 (BASF) (contains 48 wt % | 1.788 | 1.774 |
| of butyl glycol) | | |
| Melamine-formaldehyde resin | 5.644 | 5.598 |
| (Resimene 755) | | |
| Tinting paste (black) | — | 0.764 |
| Tinting paste (red) | — | 18.442 |
| Aluminum pigment (ALU STAPA IL | 6.348 | — |
| HYDROLAN 2192 NR.5) | | |
| Aluminum pigment (ALU STAPA IL | 2.727 | — |
| HYDROLAN 2197 NR.5) | | |
| Aluminum pigment (PALIOCROM- | — | 0.764 |
| ORANGE L2804 (ex EH 0) | | |
| Butyl glycol | 5.722 | 0.764 |
| Polyester prepared as per example | 5.722 | 0.764 |
| D, column 16, lines 37-59 of | | |
| DE 4009858 A1 | | |
| Aqueous solution of | 0.805 | 0.076 |
| dimethylethanolamine (10% | | |
| strength) | | |
| Mica pigment (MEARLIN EXT. FINE | — | 2.246 |
| RUSSET 459 V) | | |
| Mica pigment (MEARLIN EXT. SUPER | — | 0.764 |
| RUSSET 459 Z) | | |
| Mixing varnish prepared as per | — | 9.365 |
| column 11, lines 1 to 13 of | | |
| EP 1534792 B1 | | |
| TINUVIN 384-2, 95% MPA | 0.536 | 0.640 |
| TINUVIN 123 | 0.358 | 0.430 |
| BYK-381 | — | 0.478 |
| Water | 21.314 | 8.122 |
| Aqueous solution of | | |
| dimethylethanolamine (10% | 0.590 | 0.956 |
| strength) | | |

Basecoat materials 5 and 6 are stable on storage at 40° C. for at least 4 weeks, meaning that within this time they show no sedimentation tendency at all and no significant change (less than 15%) in the low-shear viscosity (shearing load of 1 s⁻¹, measured with a rotational viscosimeter). Basecoat material 5 has a solids content of 31% and a calculated volume solids content of 27%. Basecoat material 6 has a solids content of 38% and a calculated volume solids content of 34%.

TABLE 5
Basecoat materials 7 (silver) and 8 (red),
based on mixing varnish system 2

| | BC 7 | BC 8 |
|---|---|---|
| | (silver) | (red) |
| Component | Parts by wt. | Parts by wt. |
| Dispersion (PD) | 31.355 | 30.283 |
| Butyl glycol | 2.613 | 2.524 |
| Water | 6.387 | 6.169 |
| Polyester prepared as per example | 7.258 | 7.010 |
| D, column 16, lines 37-59 of | | |
| DE 4009858 A1 | | |
| Polyurethane-polyacrylate | 5.226 | 5.047 |
| copolymer dispersion prepared as | | |
| per page 7, line 55 to page 8, | | |
| line 23 of DE 4437535 A1 | | |
| Aqueous solution of | 1.887 | 1.822 |
| dimethylethanolamine (10% | | |
| strength) | | |
| Polypropylene glycol | 0.871 | 0.841 |
| TMDD BG 52 (BASF) (contains 48 wt % | 1.742 | 1.682 |
| of butyl glycol) | | |
| Tinting paste (black) | | 0.540 |
| Tinting paste (red) | | 12.800 |
| Aluminum pigment (ALU STAPA IL | 4.666 | |
| HYDROLAN 2192 NR.5) | | |
| Aluminum pigment (ALU STAPA IL | 2.000 | |
| HYDROLAN 2197 NR.5) | | |
| Aluminum pigment (PALIOCROM- | | 0.540 |
| ORANGE L2804 (ex EH 0) | | |
| Mica pigment (MEARLIN EXT. FINE | | 1.620 |
| RUSSET 459 V) | | |
| Mica pigment (MEARLIN EXT. SUPER | | 0.540 |
| RUSSET 459 Z) | | |
| Mixing varnish prepared as per | 13.332 | 8.100 |
| column 11, lines 1 to 13 of | | |
| EP 1534792 B1 | | |
| Butyl glycol | 5.000 | 2.700 |
| Organic thickener (PAc thick., | 7.500 | 5.400 |
| AS S 130 sol.) | | |
| Water | 10.000 | 10.000 |
| Water | 4.000 | 4.000 |
| Aqueous solution of | 1.700 | 2.000 |
| dimethylethanolamine (10% | | |
| strength) | | |

Basecoat materials 7 and 8 are stable on storage at 40° C. for at least 4 weeks, meaning that within this time they show no sedimentation tendency at all and no significant change (less than 15%) in the low-shear viscosity (shearing load of 1 s⁻¹, measured with a rotational viscosimeter). Basecoat material 7 has a solids content of 22% and a calculated volume solids content of 19%. Basecoat material 8 has a solids content of 24% and a calculated volume solids content of 21%.

Production of the Abovementioned Tinting Pastes:

The tinting paste (black) was produced from 25 parts by weight of an acrylated polyurethane dispersion prepared as per international patent application WO 91/15528 binder dispersion A, 10 parts by weight of carbon black, 0.1 parts by weight of methyl isobutyl ketone, 1.36 parts by weight of dimethylethanolamine (10% strength in DI water), 2 parts by weight of a commercial polyether (Pluriol® P900 from BASF SE), and 61.45 parts by weight of deionized water.

The tinting paste (white) was produced from 43 parts by weight of an acrylated polyurethane dispersion prepared as per international patent application WO 91/15528 binder dispersion A, 50 parts by weight of titanium rutile 2310, 3 parts by weight of 1-propoxy-2-propanol, and 4 parts by weight of deionized water.

The tinting paste (red) was produced from 38.4 parts by weight of an acrylated polyurethane dispersion prepared as per international patent application WO 91/15528 binder dispersion A, 47.1 parts by weight of Bayferrox® 13 BM/P, 0.6 part by weight of dimethylethanolamine (10% strength in DI water), 4.7 parts by weight of a commercial polyether (Pluriol® P900 from BASF SE), 2 parts by weight of butyl glycol, and 7.2 parts by weight of deionized water.

Production of Multicoat Paint Systems Using Basecoat Materials 1 to 8, and Performance Investigation of These Paint Systems

(a) Production by the Inventive Process, Two Basecoat Films

Substrates used for the paint system were steel panels on which a cured electrocoat was produced using a commercial cathodic electrocoat material.

First of all, as color-preparatory basecoat material, a gray basecoat material (BC 1 or BC 3) was applied by electrostatic spray application in a film thickness of 20 micrometers and was then flashed at room temperature for 3 minutes. Applied over this first basecoat film was a color and/or effect basecoat material (BC 2, BC 4 to BC 8), in each case via electrostatic spray application, in a film thickness of 20 micrometers, each film being flashed at room temperature for 4 minutes and subjected to interim drying at 60° C. for 5 minutes. Applied over this interim-dried basecoat film was a commercial two-component clearcoat material in a film thickness of 35-45 micrometers, by electrostatic spray application, and the entire system was then again flashed at room temperature for 10 minutes and subsequently cured at 140° C. for 20 minutes.

For the determination of the pinholing limit, moreover, multicoat paint systems were produced in which, in contrast to the paint systems described above, the second basecoat material was applied as a wedge (film thicknesses up to 40 micrometers).

With regard to flow and appearance, the multicoat paint systems were investigated using a WaveScan measuring instrument (from Byk-Gardner) (shortwave, longwave), with low values corresponding to improved flow. In addition, the pinholing limit was investigated. The tendency to form pinholes goes up with the increase in the thickness of a coating film (in this case, the second basecoat film), since correspondingly higher amounts of air, organic solvents and/or water are required to escape from the film. The thickness of this film above which pinholes are in evidence is referred to as the pinholing limit. The higher the pinholing limit, the better, evidently, the quality of the stability toward pinholes.

Investigations were also carried out into the adhesion properties. Tests conducted were the cross-cut test to DIN EN ISO 2409, the stonechip test to PV3.14.7 in accordance with DIN EN ISO 20567-1, the steam jet test to PV1503 with adaptation to DIN 55662, optionally in combination with the condensation water test (CWT) to PV3.16.1 in accordance with DIN EN ISO 6270-2. Low values here correspond to good adhesion.

Tables A and B show the corresponding results.

TABLE A
Flow measurements and pinholing limits

| | Shortwave | Longwave | Pinholing limit |
|---|---|---|---|
| BS 1 Gray and | 19 | 7 | >40 μm |
| BS 5 Silver | | | |
| BS 1 Gray und | 18 | 7 | >40 μm |
| BS 2 White | | | |
| BS 1 Gray and | 17 | 11 | >40 μm |
| BS 6 Red | | | |
| BS 3 Gray and | 27 | 8 | >40 μm |
| BS 7 Silver | | | |
| BS 3 Gray and | 27 | 9 | >40 μm |
| BS 4 White | | | |
| BS 3 Gray and | 22 | 11 | >40 μm |
| BS 8 Red | | | |

TABLE B
Adhesion properties

| | | Cross-cut | | Steam jet | |
|---|---|---|---|---|---|
| | | before | after | before | after |
| | Stonechip | CWT | CWT | CWT | CWT |
| BS 1 Gray | ≤1.5 | ≤1 | ≤1 | ≤1 mm | ≤1 mm |
| BS 5 Silver | | | | | |
| BS 1 Gray | ≤1.0 | ≤1 | ≤1 | ≤1 mm | ≤1 mm |
| BS 2 White | | | | | |
| BS 1 Gray | ≤1.5 | ≤1 | ≤1 | ≤1 mm | ≤1 mm |
| BS 6 Red | | | | | |
| BS 3 Gray | ≤1.0 | ≤1 | ≤1 | ≤1 mm | ≤1 mm |
| BS 7 Silver | | | | | |
| BS 3 Gray | ≤1.0 | ≤1 | ≤1 | ≤1 mm | ≤1 mm |
| BS 4 White | | | | | |
| BS 3 Gray | ≤1.5 | ≤1 | ≤1 | ≤1 mm | ≤1 mm |
| BS 8 Red | | | | | |

The results show that the flow of the multicoat paint systems is outstanding. The pinholing limit as well was still not reached at a film thickness for the second basecoat material of 40 micrometers, and is therefore very good. The same applies to the adhesion properties of the multicoat paint systems.

(b) Production According to the Inventive Process, One Basecoat Film

Substrates used for the paint system were steel panels on which a cured electrocoat was produced using a commercial cathodic electrocoat material.

First of all, in each case a color and/or effect basecoat material (BC 2, BC 5) was applied by electrostatic spray application in a film thickness of 35 micrometers, then flashed at room temperature for 4 minutes, and subsequently subjected to interim drying at 60° C. for 5 minutes. Applied over this interim-dried basecoat film was a commercial two-component clearcoat material in a film thickness of 35-45 micrometers, by electrostatic spray application, and the entire system was then again flashed at room temperature for 10 minutes and subsequently cured at 140° C. for 20 minutes.

The adhesion properties were investigated as under (a). Table C shows the results.

TABLE C
Adhesion properties

| | | Cross-cut | | Steam jet | |
|---|---|---|---|---|---|
| | | after | before | after | before |
| | Stonechip | CWT | CWT | CWT | CWT |
| BS 5 Silver | ≤1.5 | ≤1 | ≤1 | ≤1 mm | ≤1 mm |
| BS 2 White | ≤1.0 | ≤1 | ≤1 | ≤1 mm | ≤1 mm |

It is evident that the multicoat paint systems produced exhibit very good adhesion.

(C) Production According to the Standard Prior Art Method

Substrates used for the paint system were steel panels on which a cured electrocoat was produced using a commercial cathodic electrocoat material.

First of all a commercial gray surfacer was applied by electrostatic spray application in a film thickness of 30 micrometers, followed by flashing at room temperature for 10 minutes and then by curing at 155° C. for 20 minutes. Applied over this cured surfacer coat was a color and/or effect basecoat material, in each case via electrostatic spray application, in a film thickness of 20 micrometers (BC 2 and BC 3) or 15 micrometers (BC 5 and BC 7), each film being flashed at room temperature for 3 minutes and subjected to interim drying at 80° C. for 5 minutes. Applied over this interim-dried basecoat film was a commercial two-component clearcoat material in a film thickness of 35-45 micrometers, by electrostatic spray application, and the entire system was then again flashed at room temperature for 10 minutes and subsequently cured at 150° C. for 20 minutes.

The adhesion properties and the pinholing behavior were investigated as under (a). Table D shows the results.

| | Shortwave | Longwave | Pinholing limit |
|---|---|---|---|
| BS 5 Silver | 23 | 13 | >40 μm |
| BS 2 White | 13 | 7 | >40 μm |
| BS 7 Silver | 22 | 15 | >40 μm |
| BS 4 White | 14 | 8 | >40 μm |

The results show that even when the standard method is employed, the properties are good, although this method differs from the process of the invention in requiring an additional curing step. Looking at all of the results overall, it is apparent that the multicoat paint systems of the invention produced by the process of the invention are at least of comparable quality, in terms of their profile of properties, to the systems produced by the standard method, but can be produced in a more economical way. Accordingly, as a result of the present invention, success is achieved in providing a process which unites an economical procedure with outstanding properties for the paint systems produced.

### BRIEF DESCRIPTION OF THE FIGURES

FIG. 1:

Schematic construction of a multicoat paint system (M) of the invention disposed on a metallic substrate (S), the system (M) comprising a cured electrocoat (E.1) and also a basecoat film (B.2.1) and a clearcoat film (K) which have been jointly cured.

FIG. 2:

Schematic construction of a multicoat paint system (M) of the invention disposed on a metallic substrate (S), the system (M) comprising a cured electrocoat (E.1), two basecoat films (B.2.2.x), namely a first basecoat film (b.2.2.a) and a topmost basecoat film (b.2.2.z) disposed over it, and a clearcoat film (K), which have been jointly cured.

FIG. 3:

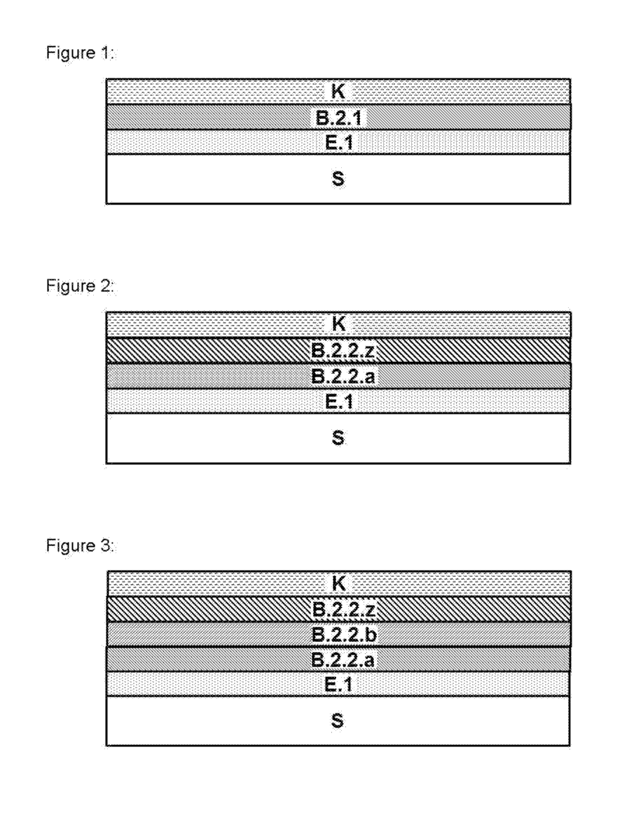

Schematic construction of a multicoat paint system (M) of the invention disposed on a metallic substrate (S), the system (M) comprising a cured electrocoat (E.1), three basecoat films (B.2.2.x), namely a first basecoat film (b.2.2.a), a basecoat film (b.2.2.b) disposed over it, and a topmost basecoat film (b.2.2.z), and also a clearcoat film (K), which have been jointly cured.

1. A process for producing a multicoat paint system (M) on a metallic substrate (S), the process comprising:
(1) electrophoretically applying an electrocoat material (e.1) to a metallic substrate (S) and subsequent curing of the electrocoat material (e.1), to obtain a cured electrocoat (E.1) on the metallic substrate (S);
(2) applying an aqueous basecoat material (b.2.1) directly to the cured electrocoat (E.1) or directly successively applying two or more basecoat materials (b.2.2.x) to the cured electrocoat (E.1), to obtain a basecoat film (B.2.1) or to obtain two or more directly successive basecoat films (B.2.2.x) directly on the cured electrocoat (E.1);
(3) applying a clearcoat material (k) directly to the basecoat film (B.2.1) or a topmost basecoat film of the two or more directly successive basecoat films (B.2.2.x), to obtain a clearcoat film (K) directly on the basecoat film (B.2.1) or to obtain a topmost basecoat film (B.2.2.x) directly on the basecoat film (B.2.1); and
(4) jointly curing the basecoat film (B.2.1) and the clearcoat film (K) or jointly curing the two or more directly successive basecoat films (B.2.2.x) and the clearcoat (K), to obtain a multicoat paint system (M) on the metallic substrate (S),
wherein:
the basecoat material (b.2.1) or at least one of the two or more basecoat materials (b.2.2.x) comprises at least one aqueous polyurethane-polyurea dispersion (PD) comprising polyurethane-polyurea particles; and
the polyurethane-polyurea particles present in the dispersion (PD) comprise anionic groups, groups which can be converted into anionic groups, or both, and have an average particle size of 40 to 2000 nm and also a gel fraction of at least 50%.

2. The process as claimed in claim 1, wherein:
the polyurethane-polyurea particles, in each case in reacted form, comprise
(Z.1.1) at least one isocyanate group-containing polyurethane prepolymer comprising the anionic groups, the groups which can be converted into anionic groups, or both, and
(Z.1.2) at least one polyamine comprising two primary amino groups and one or two secondary amino groups; and
the dispersion (PD) comprises at least 90 wt % of the polyurethane-polyurea particles, and water.

3. The process as claimed in claim 1, wherein the anionic groups, the groups which can be converted into anionic groups, or both, are carboxylate group, carboxylic acid groups, or both.

4. The process as claimed in claim 2, wherein the polyamine (Z.1.2) comprises one or two secondary amino groups, two primary amino groups, and aliphatically saturated hydrocarbon groups.

5. The process as claimed in claim 1, wherein the polyurethane-polyurea particles present in the dispersion (PD) have an average particle size of 110 to 500 nm and a gel fraction of at least 80%.

6. The process as claimed in claim 1, wherein the basecoat material (b.2.1) or at least one of the two or more basecoat materials (b.2.2.x) further comprises at least one hydroxy-functional polymer as binder, said at least one hydroxy-functional polymer selected from the group consisting of a polyurethane, a polyester, a polyacrylate and copolymers thereof.

7. The process as claimed in claim 1, wherein the basecoat material (b.2.1) or at least one of the two or more basecoat materials (b.2.2.x) is a one-component coating material.

8. The process as claimed in claim 1, wherein the joint curing (4) is carried out at temperatures of 100 to 250° C. for a duration of 5 to 60 min.

9. The process as claimed in claim 1, wherein at least two directly successive basecoat films (B.2.2.x) are produced, said basecoat films (B.2.2.x) comprising a first basecoat film (B.2.2.a) directly on the cured electrocoat (E.1) comprising at least one white pigment and at least one black pigment, and at least one further basecoat film (B.2.2.x) comprising at least one effect pigment.

10. The process as claimed in claim 1, wherein:
when the basecoat material (b.2.1) and the two or more basecoat materials (b.2.2.x) comprise at least one crosslinking agent, they have a solids content of at least 25%; and
when the basecoat material (b.2.1) and the two or more basecoat materials (b.2.2.x) contain no crosslinking agent, they have a solids content of at least 15%.

11. The process as claimed in claim 10, wherein the basecoat materials (b.2.1) and (b.2.2.x) have a viscosity of 40 to 150 mPa·s at 23° C. under a shearing load of 1000 l/s.

12. The process as claimed in claim 1, wherein the basecoat material (b.2.1) or at least one of the basecoat materials (b.2.2.x), comprises at least one crosslinking agent selected from the group consisting of the a blocked polyisocyanate and an aminoplast resin.

13. The process as claimed in claim 2, wherein the prepolymer (Z.1.1) comprises at least one polyester diol prepared from diols and dicarboxylic acids, with at least 50 wt of the dicarboxylic acids being dimer fatty acids.

14. The process as claimed in claim 1, wherein the basecoat material (b.2.1) or the two or more basecoat materials (b.2.2.x) are applied to the cured electrocoat (E.1) by electrostatic spray application or pneumatic spray application.

15. A multicoat paint system (M) produced by the process of claim 1.
